(19) United States
(12) Patent Application Publication
(10) Pub. No.: US 2012/0205306 A1
(43) Pub. Date: Aug. 16, 2012

(54) MULTI-LAYERED BLOOD COMPONENT EXCHANGE DEVICES, SYSTEMS, AND METHODS

(75) Inventors: Ilan K. Reich, New York, NY (US); Edward F. Leonard, Bronxville, NY (US); Michael Hill, Wyckoff, NJ (US); John Howard, Salem, MA (US)

(73) Assignee: THE TRUSTEES OF COLUMBIA UNIVERSITY IN THE CITY OF NEW YORK, NEW YORK, NY (US)

(21) Appl. No.: 13/392,519

(22) PCT Filed: Aug. 27, 2010
(86) PCT No.: PCT/US10/47041

§ 371 Date: May 4, 2012

(30) Foreign Application Priority Data
Aug. 28, 2009 (US) 61238068
Jan. 11, 2010 (US) 61293956

(51) Int. Cl. B01D 17/00

(52) U.S. Cl. 210/519

(57) ABSTRACT

A microfluidic separation device suitable for high throughput applications such as medical treatments, and associated methods and systems, are described. Embodiments are suitable for treatment of end stage renal disease.

### CROSS-REFERENCE TO RELATED APPLICATIONS

The present application claims the benefit of U.S. Provisional Application No. 61/238,068, filed Aug. 28, 2009, and U.S. Provisional Application No. 61/293,956, filed Jan. 11, 2010, both of which are hereby incorporated by reference herein in their entireties.

### FIELD

The present disclosure relates generally to fluid separation devices, systems, and methods, and more particularly, to multi-layered fluid separation devices and systems, and methods employing multi-layered separation components for processing fluids, such as blood.

### BACKGROUND

Blood component exchange devices for medical treatment are known. For example, devices and systems for apheresis, hemodialysis, hemofiltration, adsorbent-based dialysis, apheresis, plasmapheresis, have existed for a long time and continue to be refined. Most of such systems make use of devices such as centrifugation and filter membranes for discrimination between blood components. Recently, systems have been proposed in which blood components are exchanged between blood and another fluid which are permitted to be in direct contact with each other. Also, the present inventors have proposed systems employing cross-flow filtration to provide a number of medical treatment modalities. There remains a need for improvements and alternatives to existing systems including proposals for addressing the attending manufacturing and reliability challenges.

### BRIEF DESCRIPTION OF DRAWINGS

Embodiments will hereinafter be described with reference to the accompanying drawings, wherein like reference numerals represent like elements. The accompanying drawings have not necessarily been drawn to scale. Where appropriate, some features may not be illustrated to assist in the illustration and description of underlying features.

FIG. 1A is a schematic diagram of a fluid separation system employing a multi-layer separation device with membraneless separation channels, according to embodiments of the disclosed subject matter.

FIG. 1B is a schematic diagram of an alternative fluid separation system employing a multi-layer separation device with membraneless separation channels, according to embodiments of the disclosed subject matter.

FIGS. 2A-2B are schematic diagrams showing sample and sheath fluid (cytoplasmic body-depleted blood fluid fraction) flows in multiple channels of a multi-layer separation device, according to embodiments of the disclosed subject matter.

FIG. 3 is a schematic diagram showing a close-up of a single separation channel in the multi-layer separation device of FIG. 2B.

FIG. 4A is an exploded isometric view of a multi-layer separation device, according to embodiments of the disclosed subject matter.

FIG. 4B is a schematic diagram showing an arrangement of the various layers of the multi-layer separation device of FIG. 4A.

FIG. 5 is an exploded isometric view showing the layer components of one of the separation channels of the multi-layer separation device of FIG. 4A.

FIG. 6 is an alternate view of the layer components of FIG. 5 showing the flow of fluids through a single separation channel in the multi-layer separation device.

FIG. 7 is an isometric view a plenum layer together with a filter layer for the multi-layer separation device of FIG. 5.

FIG. 8 is an isometric view showing fluid flow in a plenum layer of the multi-layer separation device of FIG. 7.

FIG. 9 is an isometric view of a plenum layer together with a filter layer for the multi-layer separation device of FIG. 5 with fluid manifolds installed.

FIG. 10 is an isometric view showing fluid flow in the plenum layer of the multi-layer separation device of FIG. 9.

FIG. 11A is a side view one of the fluid manifolds for use with the multi-layer separation device, according to embodiments of the disclosed subject matter.

FIG. 11B is an isometric view of the fluid manifold of FIG. 11A.

FIG. 11C is an isometric view of a grommet component of the fluid manifold, according to embodiments of the disclosed subject matter.

FIG. 11D is an isometric view of an end cap component of the fluid manifold, according to embodiments of the disclosed subject matter.

FIG. 12 is a cross-sectional view of the filter layer for use with a multi-layer separation device, according to embodiments of the disclosed subject matter.

FIG. 13 shows a section view of a separation module with angled inlets.

FIGS. 14A through 14E show embodiments of separation modules and components thereof with FIG. 14E showing a subassembly having mirror image distribution layer elements which combine to form distribution plenums; FIG. 14A showing a plan view indicating respective sections which are shown in FIGS. 14B, 14C, and 14D.

FIG. 15 shows plate shaped members that mate to form distribution and sheath flow channels of a blood processing module.

FIG. 16 shows a first end block and first of the plate shaped members of FIG. 15 which mate to complete distribution channels of the first plate shaped member.

FIG. 17 shows a second end block and second of the plate shaped members of FIG. 15 which mate to complete distribution channels of the first plate shaped member.

FIGS. 18A and 18B illustrate sealing and other structural feature details which are compatible with the embodiments of FIGS. 15-17.

FIGS. 19A and 19B illustrate a blood supply plenum and sheath fluid injection structure of the embodiments of FIGS. 15-17.

FIG. 20A and 20B are perspective views of a sample fluid processing module according to embodiments of the disclosed subject matter.

FIG. 21 is an exploded view of the module of FIGS. 20A and 20B.

FIG. 22 is another exploded view of the module of FIG. 21.

### DETAILED DESCRIPTION

Disclosed embodiments relate to fluid transfer and separation devices, systems, and methods, for example, for the membraneless transfer of fluid components between fluids and for the separation of fluid components. In a particular application, plasma is skimmed from blood for a diagnostic or treatment purpose, for example, ultrafiltration, plasmapheresis, or dialysis. In embodiments, the blood treatment apparatus includes multiple separation channels in which fluids flow in separate adjacent layers in each separation channel. The fluids can flow into the channel in separate layers or separate layers can form due to gravitational effect or fluid dynamic effects such may arise in a high shear microfluidic flow.

In important embodiments, one of the fluids is blood and the other is plasma and/or dialysate. The fluids can flow into the channel in adjacent layers and components of the fluids exchanged between the adjacent layers by one or more mechanisms that include diffusion. In embodiments, blood and plasma are mixed prior to entering the channel and plasma and is extracted from the channel through nanopore filters in one or more walls of the channel by a crossflow filtration process. A layering effect may arise due to the differences in fluid strain (concomitantly, shear) rate across (perpendicular to the direction of) the flow. This layering effect may enhance the separation of plasma through the nanopore filter(s). The layering effect may arise due to fluid dynamic effects, for example, solutes may be exchanged between blood and plasma and cells may concentrate in a low shear part of the flow causing a cell-free plasma fraction to be established in a separate layer of the flow. The layering may occur or be enhanced by gravity, causing the plasma components desired to be drawn through the nanopore filters to concentrate near the nanopore filter and components desired to remain in the channel to be depleted near the nanopore filter.

Although embodiments described herein are aimed at separating plasma from blood, the principles are applicable to other fluids, treatment modalities, or fluid separation processes. For example, the separation channel may be employed for microfluidic crossflow filtration on a chip for analyte separation.

A blood treatment for a patient may include separating blood components into a cytoplasmic body-depleted blood fluid fraction “CBF” (that is, fractions that are depleted of, or free of, cytoplasmic bodies such as leukocytes, erythrocytes, and platelets (thrombocytes)) and a remaining blood fraction using a primary membraneless separation device and performing a treatment on the CBF.

One type of microfluidic channel may be used to isolate from the walls of the channel blood cells in a blood flow by sheathing a cell enriched fraction (or whole blood) between sheaths of a different fluid or a cell depleted fraction (e.g., pure plasma). This may permit the treatment to be done in a manner which is highly biocompatible, reducing or eliminating the need for anti-coagulants and with a reduced level of activation of the complement system. A separation device incorporating these microfluidic channels may thus be considered membraneless in that the blood flow does not pass through a membrane within the microfluidic channels for processing; but, rather, interfaces only with another fluid. In other devices, no sheathing or even laying may occur.

For patients with end stage renal disease (ESRD), the treatments may include one or more of ultrafiltration, hemodialysis, hemofiltration, and hemodiafiltration, sorbent-based dialysis, chemical, mechanical (e.g., centrifugation), or any other type of treatment which may be facilitated or modified by performing it on a CBF rather than blood or a blood component prepared by other means. The primary membraneless separation device may be used in conjunction with an extraction fluid treatment device to provide the desired treatment on the CBF.

The devices, system, and methods described herein may selectively transfer molecular and other components from a sample fluid such as blood by contacting the sample fluid with another fluid or sample fluid fraction. Embodiments of an extraction channel or separation channel are discussed in U.S. patent application Ser. No. 11/814,117 (published as U.S. Publication No. 2009/0139931) to Leonard and filed Jul. 17, 2007, hereby incorporated by reference in its entirety. Flow patterns and species exchanges may occur when blood is flowed as a thin layer adjacent to, or between, concurrently flowing layers of an extraction fluid, without an intervening membrane (i.e., membraneless). The extraction fluid, moreover, is generally miscible with blood and diffusive and convective transport of all components may arise. In embodiments disclosed herein, the sheath fluid (cytoplasmic body-depleted blood fluid fraction or CBF) may be partly or entirely plasma that has undergone a secondary process to remove undesirable components, such as uremic toxins and/or excess water. In further embodiments, the returned sheath (or extraction) fluid that has been processed is mixed directly with blood or other sample fluid before returning to the channel.

As taught in U.S. patent application Ser. No. 11/814,117, a microfluidic flow channel capable of separating cytoplasmic bodies from other components may employ filters such as nanoporous membranes with precise, short pores and high void fractions. The embodiments of microfluidic separation channels with such wall filters described in the '117 application may be employed in, for example, in the walls of, any of the microfluidic separation channels described herein. In embodiments in which blood is mixed directly with plasma treated in the secondary separation as described in the '117 application, the wall filters serve to prevent cytoplasmic bodies from entering the secondary stream enhancing the potential effectiveness of secondary processing. The effectiveness of the wall filters is maintained by the shear rate of the fluid (e.g., blood) passing over it which sweeps particles from the surface helping to ensure against blocking of the pores of the filter(s).

By using a microfluidic channel, components of blood may be separated for further processing. Each microfluidic channel may have a height less than 1.5 mm, for example, preferably less than 200 μm, where “height” is the dimension perpendicular to the direction of flow and perpendicular to the interfacial area across which transport occurs. The height of the channel is not limited to the above-mentioned range in all embodiments and other sizes, channel shapes other than flat (e.g., cylindrical), and tapered channels, are possible. By using several microfluidic channels in parallel, a therapeutically effective amount of the blood may be processed. The present application is concerned in large part with effective ways to manufacture such multiple-channel devices. Examples of applications and further embodiments of microfluidic separation channels may be found in International Application No. PCT/US09/33111, filed Feb. 4, 2009.

Sheathing a core of blood with recirculated plasma (referred to herein as a “sheath fluid” or CBF to identify a function thereof), or assuring that the sheath fluid flows between at least a substantial portion of the blood and the enclosing boundaries of the flow path, prevents, or at least reduces contact of the blood with these boundaries. In turn, this configuration of the two fluids prevents, or at least reduces, undesirable activation of factors in the blood, thereby reducing bio-incompatibilities that have been problematic in other techniques of blood processing, including clotting, fouling and activation of the complement system.

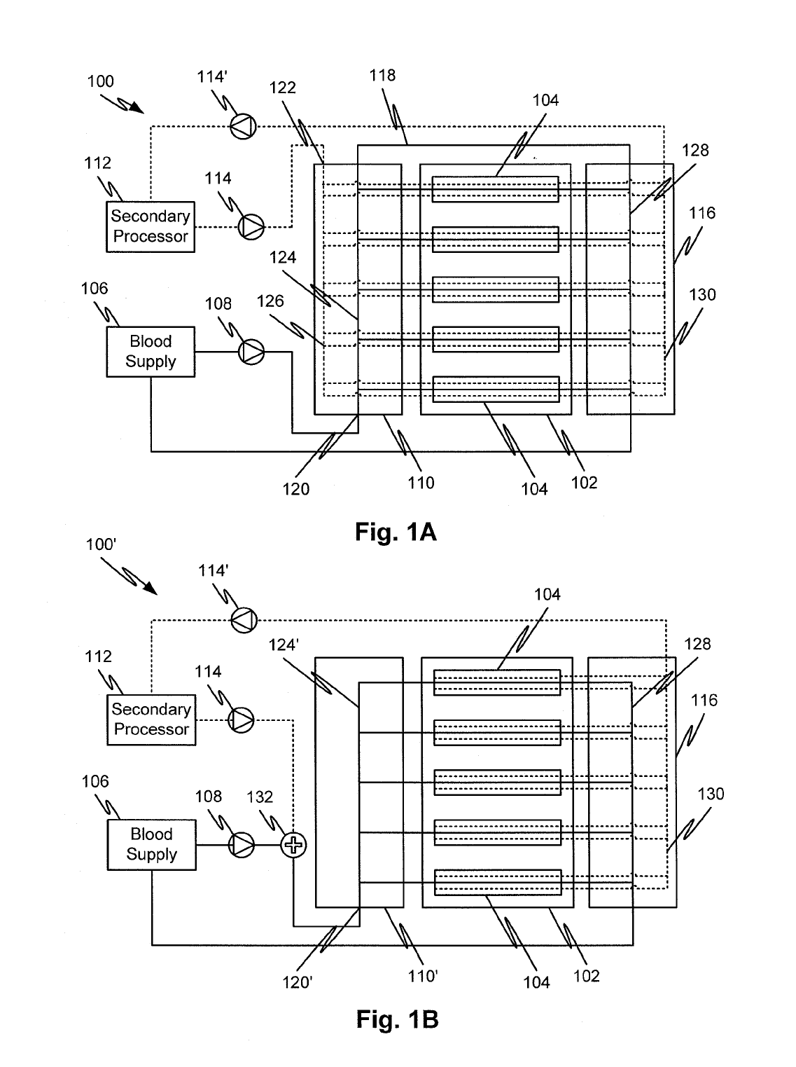

Referring now to the drawings, and in particular, FIG. 1A, an embodiment of a blood treatment system 100 is shown. Blood treatment system 100 may include a blood-plasma separation module 102, which employs one or more separation microchannels 104 for conveying blood and sheath fluid therethrough. In FIG. 1A, five such microchannels 104 are combined in a single blood-plasma separation module 102; however, various numbers of microchannels 104 within a single blood-plasma separation module 102 as well as various numbers of blood-plasma separation modules 102 are possible according to one or more of the disclosed embodiments. The separation microchannels 104 may be layered on top of each other in a single module 102 to achieve a compact device. However, other arrangements for the microchannels within one or more blood-plasma separation modules are also possible. For example, the microchannels 104 may be disposed adjacent to each other in a width direction within the blood separation module 102, thereby creating a wider but thinner device.

Within the blood-plasma separation module 102, blood may flow at, for example, 30 cc/minute in a thin microfluidic layer between two co-flowing sheath fluid layers. The transit time of the blood within each separation channel 104 may be very short, for example, less than 1 second, during which time contact of the blood with walls of the separation channel 104 is reduced and/or minimized by the co-flowing sheath fluid. The low height of the channel may result in rapid molecular and solute equilibration and/or concentration polarization, thereby enabling osmotic balance to occur, as well as toxins and other undesired components to migrate from the blood and into the sheath fluid for removal during only a brief contact interval. The extracorporeal blood volume may be less than 5 cc.

As discussed in U.S. patent application Ser. No. 11/814,117, the flow of the blood within the separation microchannel 104 is such that blood cells tend to move toward the center of the channel, i.e., away from the channel walls. Each separation microchannel 104 may have dimensions that assure laminar flow conditions are maintained even under conditions of normal use and that permit a large interface area between the sample and extraction fluids in a compact design, as described in the incorporated '117 application. The space adjacent to the channel walls tends to be primarily sheath fluid and plasma. The sheath fluid may then be siphoned from the separated blood components by an appropriate outlet at the microchannel walls. The total height of all three fluid layers (e.g., sheath, blood, sheath) in each microchannel 104 may be approximately 100 μm or less; e.g., 40-80 microns.

In each separation microchannel 104 of the blood-plasma separation module 102, blood does not contact an artificial membrane. Rather, within the separation channel 104, blood is primarily in contact with the sheathing fluid layers. There is minimal boundary wall contact, thereby reducing surface compatibility and coagulation issues. In addition, the rapid flow rate through the separation microchannel 104 ensures that no mixing or stasis of the blood occurs.

To keep stray blood cells and other desirable components from being extracted with the sheath fluid, and to ensure that only CBF leaves the microchannel for subsequent processing, the microchannel wall outlets may be provided with appropriately sized wall-filters. The wall-filter and flow dynamics may be configured such that any cells incident on a surface of the wall-filter are prevented from exiting the channel with the sheath flow outlet, and further that the cells are continuously swept away from the filter surface so as to prevent clogging. For example, a portion of the microchannel wall may be provided with a micro- or nano-pore wall-filter, such as a “microsieve” filter. A surface of the microsieve filter may be coplanar with a wall of the separation microchannel so as to minimize disruption to flow dynamics within the channel as well as to prevent cells from being caught in a protrusion or depression. Thus, sheath fluid (CBF), primarily composed of plasma after sufficient operation time, and any undesirable components contained therein may be removed the separation channel, and thereby the blood flowing therethrough, for further processing. Further processing may include, but is not limited to, treatment modalities associated with ESRD, such as removal of uremic toxins and/or excess water, as well as other blood treatment modalities. Note that the separation channel outlets may also be free of micropore filters in alternative embodiments.

An inlet manifold 110 may be provided to distribute fluid simultaneously to each of the separation microchannels 104. The inlet manifold 110 in the present embodiment provides a transition from the large scale flow of a blood supply to the microscale environment of the microchannel. For example, a blood supply 106, such as a patient, may supply blood to the inlet manifold 110 through one or more blood pumps 108. The inlet manifold 110 receives the blood through a common blood inlet 120 and then apportions (e.g., distributes at an equal rate) the blood to the respective blood inlet of each microchannel 104 via common blood input line 124. A sheath fluid source, such as secondary processor 112, may also supply sheath fluid to the inlet manifold 110 through one or more sheath fluid pumps 114. In FIG. 1, the blood pump 108 and the sheath fluid pump 114 are arranged in the input lines to the inlet manifold 110. Other configurations for the pumps 108, 114 are also possible. For example, one or more of the pumps may be arranged in the outlet lines of an outlet manifold 116, so as to pull fluid through the blood-plasma separation device. In another example, one or more pumps may be provided in the input lines of the inlet manifold 110 and the output lines of the outlet manifold 116, for example, the pump indicated at 114′.

The inlet manifold 110 receives the sheath fluid through a common sheath fluid inlet 122 and then equally distributes the sheath fluid to the respective sheath fluid inlets of each microchannel 104 via a common sheath input line 126. Note that more than one sheath fluid inlet is shown for each microchannel 104, so as to provide a sheath flow on either side of the blood flow within each microchannel 104, thereby isolating the blood flow at its top and bottom from the microchannel walls. However, fewer or additional sheath fluid inlets may be provided. Also, as illustrated in more detailed embodiments, the manifolds 110 and 116 may distribute fluid to common supply and return plenums located between adjacent separation microchannels 104.

An outlet manifold 116 may also be provided simultaneously to collect fluid from each of the separation microchannels 104. For example, the outlet manifold 116 may separately receive sheath fluid and blood which have been processed within each separation microchannel 104. The outlet manifold 116 collects the sheath fluid from each microchannel 104 into a common sheath fluid output line 130 and conveys the collected sheath fluid. Note that the collected sheath fluid, after its interaction with the blood in the microchannel 104, may contain desired and undesired components of the blood, but does not contain any blood cells. The collected sheath fluid may be conveyed from the common sheath fluid output line 130 to a secondary processor 112 for further processing.

A secondary processor 112 may be connected to the inlet manifold 110 to process sheath fluid which is supplied to the blood plasma separation module 102. In an embodiment, the secondary processor 112 removes water and small solutes from the collected sheath fluid (i.e., an ultrafiltration unit). For example, the sheath fluid may be circulated through a hollow fiber secondary processor, by which excess fluid may be removed. An ultrafiltration pump may be provided in the secondary processor so as to remove this excess water from the collected sheath fluid before recirculating the fluid back to the blood-plasma separation module. The excess water may be removed at a rate of, for example, 2 cc/min. The secondary processor, in other embodiments, may be a dialyzer with a dialysate circulation loop (not shown) that is used to cleanse the sheath fluid before circulating the sheath fluid back to the separation microchannels 104.

In other embodiments, the secondary processor 112, additionally or in the alternative, has an adsorbent that removes toxins from the blood. Thus, blood proteins and other precious components within the collected sheath fluid, which are not effectively removed by the secondary processor 112, may be recirculated back to the separation microchannels 104 by way of the inlet manifold 110. After a short time of operation of the blood-plasma separation module 102, the blood components within the sheath fluid will equilibrate with those in the flowing blood such that the sheath fluid flowing in the channels is substantially cell-free blood plasma. In embodiments where secondary processor 112 is an ultrafilter, a reservoir of dialysate or other suitable fluid may be used for priming or as an initial source of sheath fluid, which is recirculated within the blood-plasma separation module 102. In embodiments, the separation microchannels 104 may operate without any external supply of sheath fluid. In such embodiments, plasma separated from the blood during initial passes of the blood through the separation microchannels 104 may serve as sheath fluid for subsequent operation of the blood-plasma separation module 102.

The outlet manifold 116 also collects the blood exiting the microchannels 104 into a common blood output line 128 and conveys the collected blood back to the blood supply 106. For example, when the blood supply 106 is a patient, the collected blood is reintroduced into the body of the patient. In embodiments, flow rates employed by the blood-plasma separation module may be insufficient simultaneously to process an extracorporeal volume of blood from a patient 106. In such cases, it may be beneficial to process only a portion of the blood from the patient with the blood-plasma separation module 102 while a remainder of the blood is returned to the patient 106 without processing. A blood bypass line 118 may be provided which connects the common blood input line 124 of inlet manifold 110 with the common blood output line 128 of outlet manifold 116. Thus, a portion of the blood flow may bypass the blood separation module 102 and be returned to the patient via the common blood output line 128. The blood bypass line 118 may include flow control devices, such as a pump or valve, to regulate the blood flow therethrough and control the amount of blood processed by the blood-plasma separation module, although such regulation is not required. Note that a bypass line may also, or alternatively, be provided between inlet and outlet plenums instead of just the manifold. The blood bypass line is preferably effective to eliminate flow “dead-ends” which might have a negative impact on performance or patient outcomes, such as by permitting stagnation and consequent thrombosis.

Although shown as separate components, various elements of the blood treatment system 100 may be incorporated into a single device. For example, inlet manifold 110 and outlet manifold 116 may be combined into a single unit. Likewise, manifolds 110 and 116 as well as bypass line 118 may also be incorporated with the blood-plasma separation module 102 into a single unit. In other embodiments, the various fluid delivery lines of each manifold 110, 116 may be separated from other fluid delivery lines therein. For example, the sheath fluid delivery lines of inlet manifold 110 may be physically separated into a separated device or component from the blood delivery lines of inlet manifold 110. A similar arrangement is also possible for the fluid and blood lines of the outlet manifold 116. In embodiments, all components of the illustrated blood treatment system 100 may be incorporated into a single unit for use by a patient as a wearable or portable unit for ESRD therapy.

The manifolds are preferably highly polished to prevent coagulation. An alternative is to form the manifold via holes in the succession of layers and lining the resulting channel with Teflon or another material that is biocompatible. Teflon or other such materials can also be used in other areas of the device to smooth edges and transitions, such as the intersection of the plenum and slits.

An alternative arrangement for a blood treatment system 100′ is shown in FIG. 1B. Operation of the blood treatment system 100′ is similar to that of FIG. 1A, wherein like elements between the two systems having been identified with like reference numerals. However, in contrast to the system of FIG. 1A, the sheath fluid inlet flow and the blood flood are combined prior to introduction to the blood-plasma separation module 102 by a mixing process indicated symbolically at 132. Each separation microchannel 104 within the blood-plasma separation module 102 is designed such that the cells in the blood flowing through the microchannel are concentrated in a region of the channel intermediate between the walls of the channel. For example, the length of the microchannel upstream of a sheath outlet having filters therein may be sufficient so as to cause the blood cells, which are flowing through the microchannel at a velocity of at least 1 cm/sec., to concentrate in a region intermediate between the microchannel walls, thereby leaving a substantially cell-free plasma layer adjacent to microchannel walls.

Blood treatment system 100′ may thus include a mixer 132 which may combine the inlet blood flow and inlet sheath fluid flow prior to the inlet manifold 110′. The flows may be simply mixed or stirred or the two fluids simply flowed in a common channel without direct mixing. Inlet manifold 110′ may be provided with a single inlet 120′ connected to a single input flow line 124′. The combined flow may then be distributed to each microchannel 104 by the manifold 110′. In an alternative embodiment, the mixer 132 may be combined with the inlet manifold 110′, in which case separate blood and sheath fluid inlets may still be provided. The separation microchannels 104 then cause the combined flow of blood and sheath fluid to form layers in which cytoplasmic bodies are concentrated and layers in which cytoplasmic bodies are depleted permitting a cell free or cell depleted sheath fluid to be extracted from the separation microchannels 104. The configuration of FIG. 1B may have the disadvantage of not isolating cells from the walls of the separation microchannels 104 and may require a longer length of the separation microchannels 104 to cause sufficient discrimination between cytoplasmic body-depleted and enriched layers.

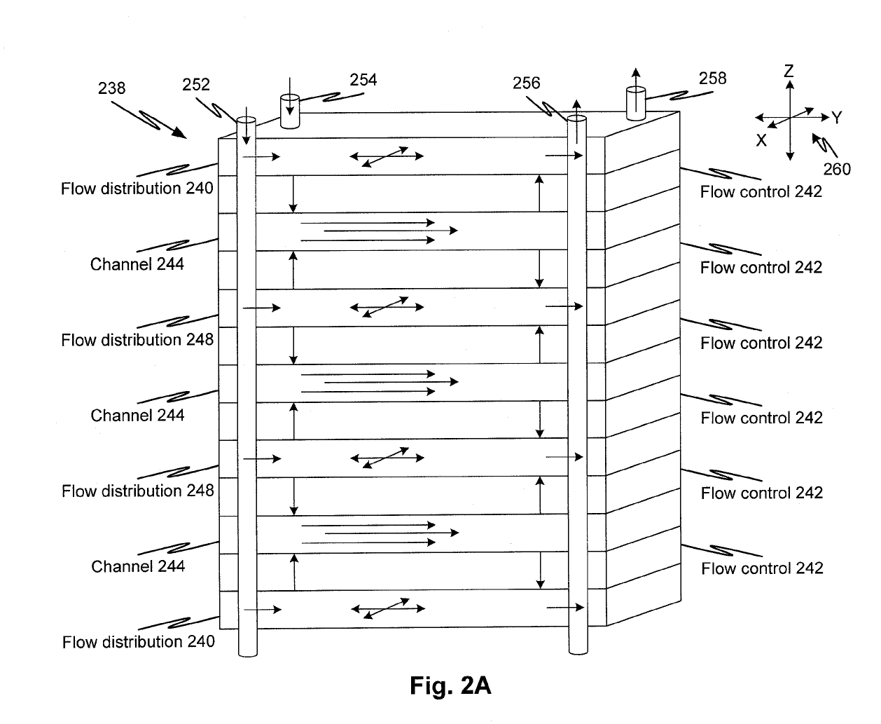

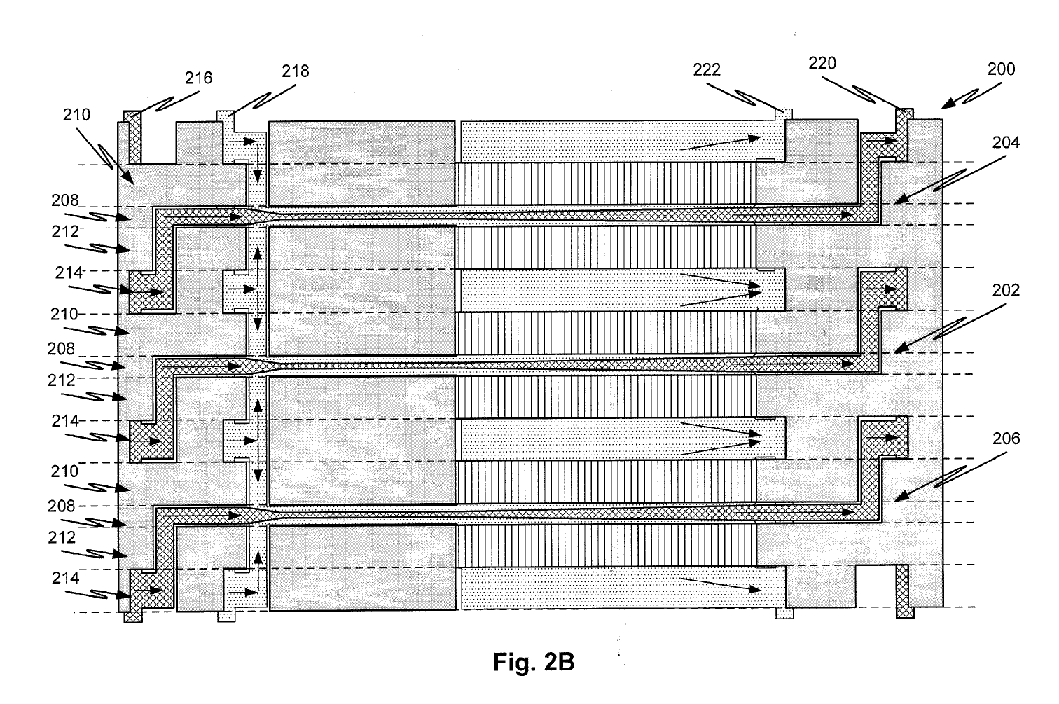

Referring now to FIG. 2A, a multiple channel separation device 238 is created by stacking and sealingly interfacing generally planar plate members 240, 242, 244, 248 each with a respective function. Manifolds 252, 254, 256, and 258 distribute and collect, respectively, fluids that co-flow in channels 244 by distributing these fluids to flow distribution members 240 and 248 and collecting the fluids from the same members after the fluids have flowed through channels in channel members 244. Flow distribution members 240 and 248 contain channels that may transfer fluids in at least one direction, for example, the X direction (the directions being defined by the legend indicated at 260). The manifolds 252, 254, 256, and 258, in this case, convey the fluids in the Z direction. The transfer of fluids in the X direction accomplishes the placement of the respective fluids at appropriate Y and X locations with respect to the channels so that, when the fluids pass into a channel in the channel member 244, they are located in a desired position to establish the required co-flow. The flow control members 242 transfer fluids from the flow distribution members 240 and 248 in the Z direction. The flow distribution members 248 may transfer fluids through flow control members 242 both above and below. Thus, for a large stack of channel members 244, the number of plates required to establish the co-flows from the manifolds 252, 254, 256, and 258 approaches 4 plate members.

By segregating the functions of the different plate members, the fabrication of the plates may be simplified, for example, the microfluidic channel (not shown separately) may be defined by a cutout through the channel plate 244 such that the major surfaces of the channel are defined by external surfaces of the adjacent flow control plates 242. The flow control plates can include through-slits, filters, or other flow control elements at appropriate locations in such a manner that these elements are continuous through the plate. For example, a slit may define a channel directly through the plate and thus form a simple two-dimensional feature. Similarly, a filter can be placed in an opening formed in the plate or be provided as a separate element with the same thickness as the flow control plates 242. The flow distribution plates 240, 248 may be formed by simple two-dimensional features as well. For example, plenums (not shown in the present figure) can be defined in the flow distribution plates 240, 248 by cutouts such that the adjacent flow control plates (and/or an end plate for flow distribution plates 240) form opposite walls of the plenums.

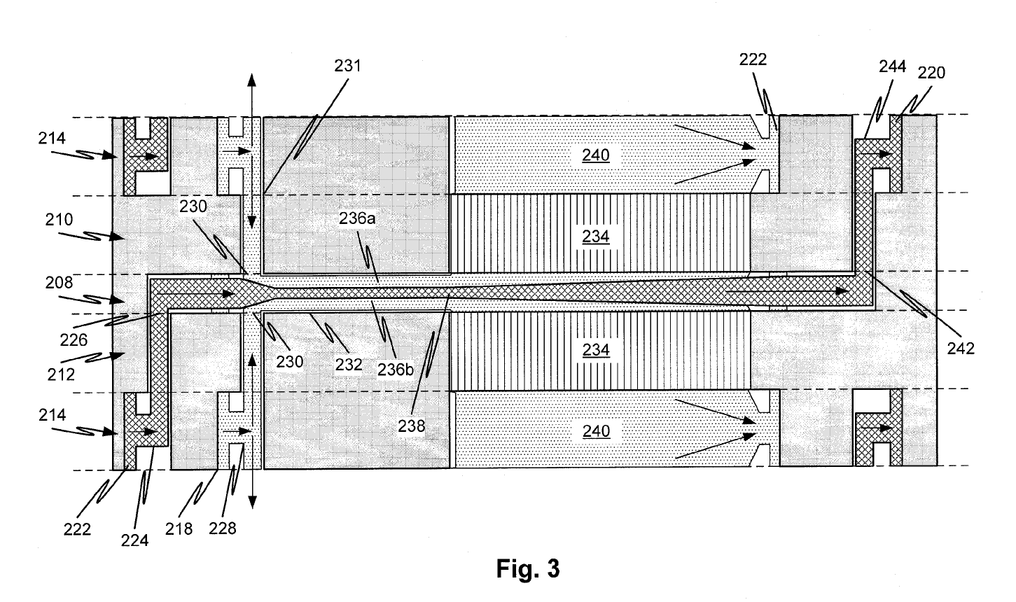

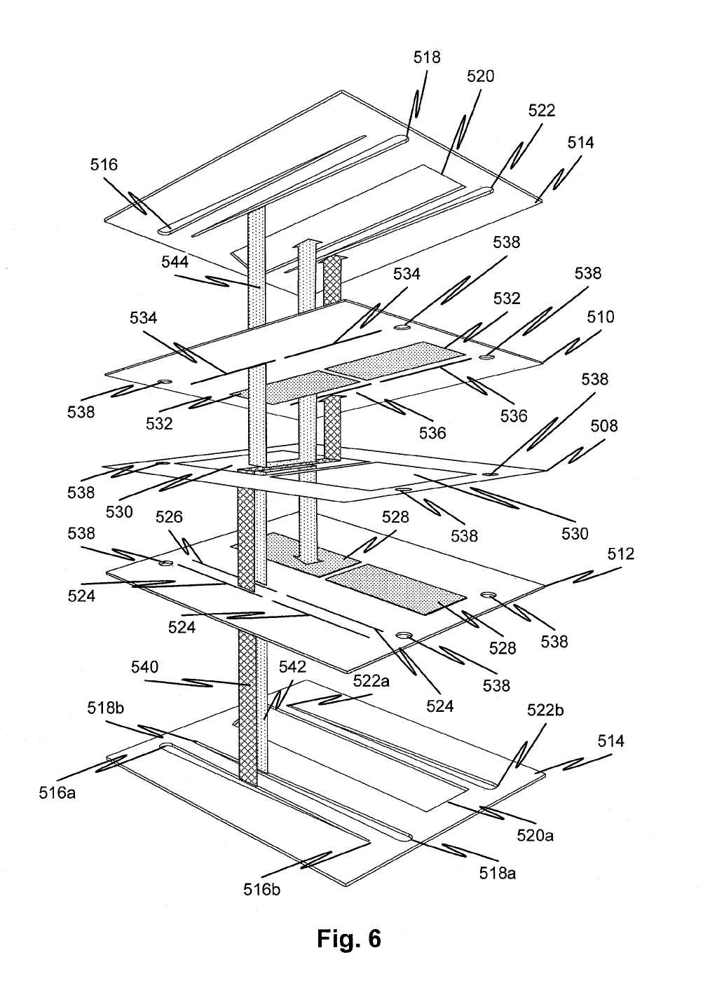

FIGS. 2B and 3, show figurative cross-sections of a multi-layer blood-plasma separation module 200 with three separation channels (202, 204, 206) and associated supporting members that distribute and collect blood and sheath fluid into and from the separation channels. FIG. 3 shows a close-up view of the middle separation channel 202. For example, a central separation channel 230 is formed in a shim layer 208. Shim layer 208 may have a thickness of, for example, approximately 100 microns, which thereby defines a height of the separation channel 230. The shim layer 208 may be a plate with a cutout such that the perimeter of the cutout defines walls perpendicular to the major walls of the separation channel 230 and the adjacent filter layers form the major walls. An example of a shim layer is shown at 508 in FIG. 6. The shim layer 208 can have one or more such cutout openings. The channel 202, 204, 206 can have a height that is less or greater than 100 microns, which is provided as an example, only. Alternatively, the shim can be formed via the raised portion at the perimeter of the wall of the microchannel, using machining, etching or other technique. Each wall may have its own shim which represents some fraction of the overall height of the desired shim or the entire shim height can be formed on just one such wall.

The top and bottom walls of a separation channel 202 are formed by a top filter member 210 and a bottom filter member 212, respectively. The top filter member 210 has a sheath fluid inlet 230 through which sheath fluid may enter the separation channel 202. The top filter member 210 also includes a filter 234, through which sheath fluid may exit the separation channel 202, and a blood outlet 242 which allows blood to exit the separation channel 202. Similarly, bottom filter member 210 also has a sheath fluid inlet 230 and a filter 234, through which sheath fluid may exit the separation channel 202. In contrast to the top filter member 210, the bottom filter member may include a blood inlet 226 which allows blood to enter the separation channel 202. Blood may thus enter separation channel 202 through the blood inlet 226 in the bottom filter member 212, flow through the separation channel 202, and exit through the top filter member 210. The sheath fluid may enter the separation channel 202 through both the top filter member 210 and the bottom filter member 212, enter the separation channel 202, and exit the separation channel 202 through the respective filters 234 in the top and bottom filter layers 210, 212.

Filters 234 may be micro- or nano-pore filters incorporated into the respective filter member to form a continuous and smooth surface so as to minimize disruption to the flow in the separation channel and help prevent thrombosis or activation of clotting factors. For example, the filter may be mounted in an appropriate receptacle of the filter member with a surface of the filter 234 being coplanar with a channel-side surface of the filter member. The filters may be any suitable filter capable of preventing blood cells, platelets, or other blood components from exiting the separation microchannel through the filter. For example, the filters 234 may be nanoporous filters fabricated using lithographic techniques. Preferably, the filter and the separation microchannel are configured such that any blood cells incident on the surface of the filter 234 are swept by maintaining a minimum shear rate across the entire surface of the filter.

To supply and remove blood and sheath fluid simultaneously to each of the separation channels 202, 204, 206, the blood-plasma separation module 200 includes a manifold/plenum system. A plenum member 214 is provided between each top filter member 210 and bottom filter member 212. In effect, each plenum member 214, other than those at the ends of the blood-plasma separation module, are shared between a top filter member of one separation channel and a bottom filter member of an adjacent separation channel. Blood from a common blood inlet line 216 enters distribution line 224 in plenum member 214. The distribution line 224 is fluidly connected to the blood inlet 226 so as to introduce blood into the separation channel 202 in the shim member 208. Similarly, sheath fluid from a common sheath fluid inlet line 218 enters distribution lines 228 in plenum member 214. As the plenum member 214 is located between the top filter member 210 and bottom filter member 212 of adjacent separation channels, the sheath fluid distribution line 228 is connected to inlets 230 of top filter member 210 and bottom filter 212 so as simultaneously to provide sheath fluid to the respective adjacent separation channels. Thus, a top plenum member 214 provides sheath fluid to the inlet 230 in the top filter member 210 while a bottom plenum member 214 provides sheath fluid to the inlet 230 in the bottom filter member 210. Filter layers 210, 212 may also be fabricated with the filter 234 monolithically formed therein. For example, the filter layers 210, 212 may be provided with an array of appropriately sized pores or outlets to function as filter 234. Such a wall structure may be fabricated using photolithographic techniques as used currently to fabricate the nanopore filter “chips.” The slits and nanopore filters may be fabricated in a single block of material to form the filter layer. For example, the filter layer may be of Silicon with thin layers (e.g., silicon nitrite) deposited and lithographically machined thereon.

Plenum member 214 further includes a filter outlet line 240. Sheath fluid that passes through the filter 234 of the top filter member 210 or which passes through the filter 234 of the bottom filter member 212 enters the filter outlet line 240. The filter outlet line 240 of the plenum member 214 is fluidly connected to a common sheath fluid outlet line, so as to remove the sheath fluid that has interacted with the blood in the separation channel. Plenum member 214 also includes a blood outlet line 244. Blood exiting the separation channel from 202 from blood outlet 242 is conveyed to the blood outlet line 244, where it joins with a common blood outlet line 220. Blood outlet line 220 may be connected to, for example, a patient for reintroduction back into the patient.

Within the separation channel 202, blood flow is sheathed by the sheath fluid so as to isolate the blood flow at its top and bottom from a substantial portion of the separation channel walls. That is, blood entering through blood inlet 226 in bottom filter member 212 enters the separation channel within the shim member and is combined with sheath flows entering through sheath fluid inlet 230 in top filter member 210 and bottom filter member 212. Within channel portion 232, the top sheath fluid flow 236a isolates the blood flow between the top filter member 210 and the blood flow 238 while the bottom sheath flow 236b isolates the blood flow between the bottom filter member 212 and the blood flow 238. As the sheath fluid passes by filters 234 in the top filter member 210 and the bottom filter member 212, portions of the sheath fluid layers 236a, 236b, pass therethrough. All or a portion of the sheath fluid layers 236a, 236b may be removed through the filters 234 by appropriate control of flow rates (e.g., pumping rates) in the blood-plasma separation module. The blood along with any sheath fluid remaining in the separation channel 202 after the filters 234 exit through blood outlet 242 to the blood outlet line 244 in plenum member 214, whereby it is conveyed back to the patient or blood supply via blood outlet line 220.

Although shown in the FIGS. 2-3 and discussed herein as separate layers, it is also possible that one or more of the layers may be combined into a single member or manufactured as a single composite device. For example, the plenum member may include two separate layers, which, when assembled, together form the illustrated plenum member 214. In another example, a composite plenum/filter member may be formed of the bottom filter member 212, a plenum member 214, and a top filter member 210. The composite plenum/filter layers may be alternated with shim layers in a layered device to form multiple separation channels in a blood-plasma separation module.

It is further noted that the configurations for the blood-plasma separation module are for illustration purposes only. Other configurations for the layers and/or flow patterns within the blood-plasma separation module are possible according to one or more contemplated embodiments. For example, the blood outlet 242 may be provided in the bottom filter member 212 rather than the top filter member 210. Similarly, the blood inlet 226 may be provided in the top filter member 210 rather than the bottom filter member 212. In another example, the blood inlet 226 and the blood outlet 242 may be provided in the same filter member. In still another example, each of the top filter member 210 and the bottom filter member 212 may be provided with a blood inlet 226 and a blood outlet 242, such that blood flow may flow from/to two different plenum layers 214.

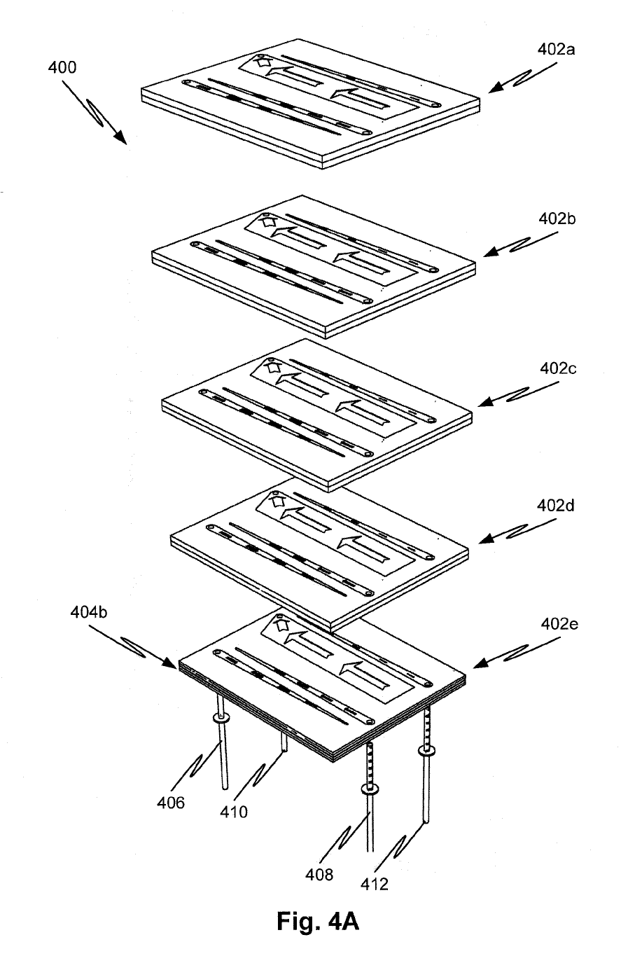

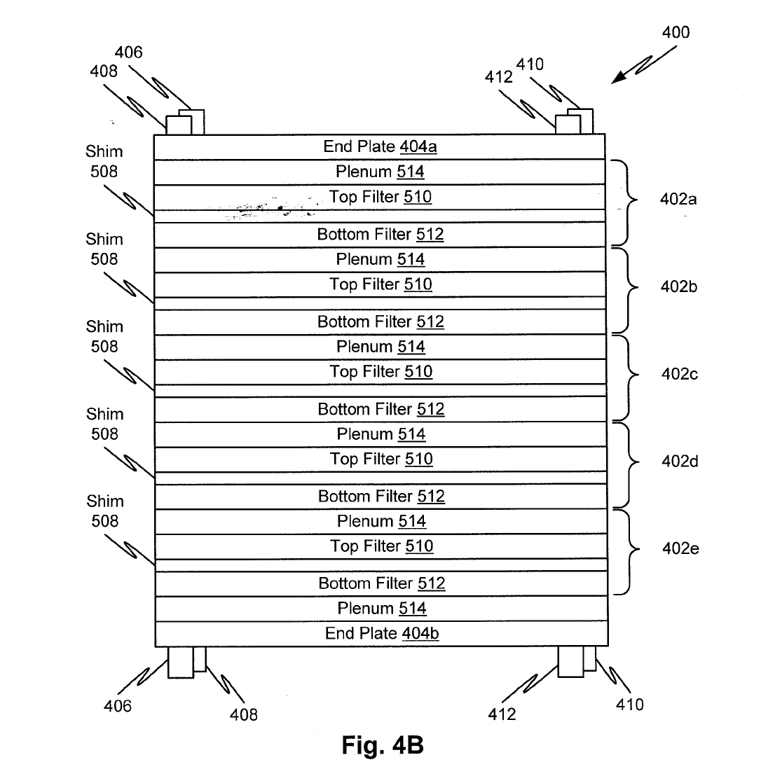

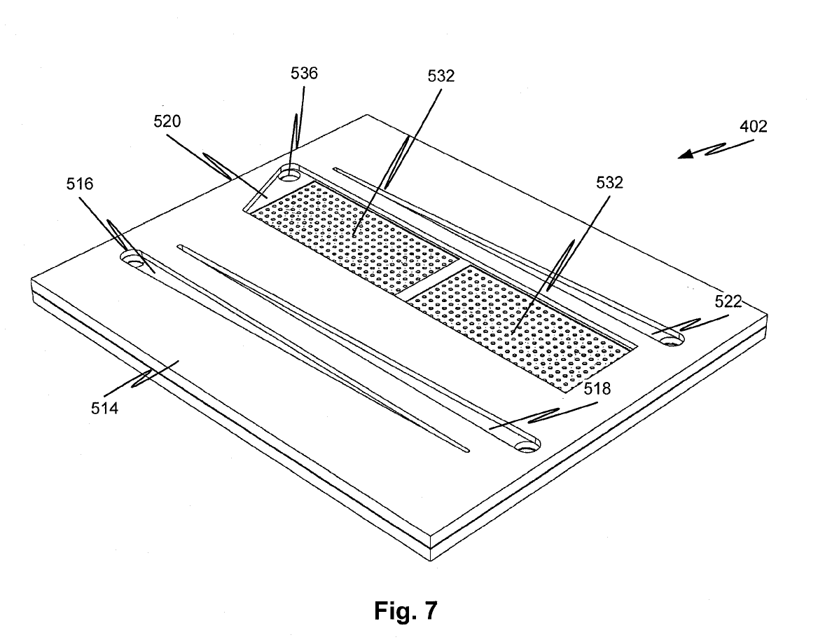

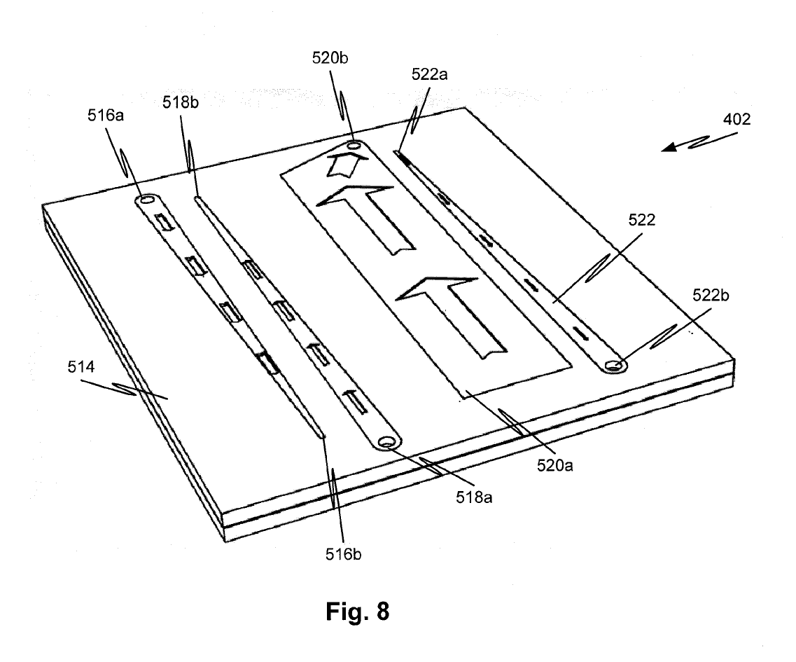

Referring now to FIGS. 4A-8, various views of an embodiment of a blood-plasma separation module 400 are shown. Blood-plasma separation 400 includes a plurality of different layers, each layer forming a component of a separation channel module 402. With reference to FIGS. 4A-4B, the blood plasma separation device may include five separation channel modules 402a-402e, each separation channel module 402a-e including at least one separation microchannel and associated plenum network for supplying blood and sheath fluid thereto and removing the processed blood and sheath fluids therefrom. The plenum network may interface with manifolds 406, 408, 410, and 412. Manifold 406 may supply blood from a blood source, such as a patient, to each plenum layer in separation channel modules 402a-402e. Similarly, manifold 408 may supply sheath fluid from a sheath fluid source, such as a secondary processor, to each plenum layer in separation channel modules 402a-402e. Sheath fluid processed in the separation channels of each separation channel module 402a-402e exits through filter layers back into the plenum layer, whereby manifold 410 conveys the collected sheath fluid from the plenum layers for further processing. Blood which has been processed in the separation channels exits through the separation channel through a slit into the plenum layer, whereby manifold 412 conveys the processed blood back to the blood supply.

Each of the separation channel modules 402a-402e may include an arrangement of layers, in particular a plenum layer 514, a top filter layer 510, a shim layer 508 (i.e., separation channel layer), and a bottom filter layer 512. The shim layer 508 is located between the top filter layer 510 and the bottom filter layer 512. The surfaces of the top filter layer 510 and the bottom filter layer 512 thus define the top and bottom walls of the separation microchannel. One plenum layer 514 is provided adjacent to the top filter layer 510. The plenum layer 514 from an adjacent separation channel module 402 (for example, channel module 402b for channel module 402a) is provided adjacent to the bottom filter layer 512. Thus, the plenum layer 514 may be shared between the top filter layer 510 of one separation channel module (e.g., 402b) and the bottom filter layer 512 of another separation channel module (e.g., 402a).

In alternative embodiments, each separation channel module 402 may include a plenum layer 514 for the top filter layer 510 and a plenum layer 514 for the bottom filter layer 512. Thus, the plenum layer 514 for the bottom filter layer 512 for one separation channel module (e.g., 402a) may be adjacent to and in communication with the plenum layer 514 for the top filter layer 510 of an adjacent separation channel module (e.g., 402b), in effect creating a plenum layer 514 that is shared between adjacent separation channel modules.

The separation channel modules 402a and 402e are illustrated in FIGS. 4A-4B as being at the ends of the blood-plasma separation module 400. Since these end modules do not have adjacent separation modules at one of their surfaces, an end plate may be used to seal the plenum layer 514. Thus, separation channel module 402a may be provided with an end plate 404a at a top surface thereof, so as to seal the plenum layer 514 adjacent to the top filter layer 510. Similarly, separation channel module 402b may be provided with an end plate 404b at a bottom surface thereof, so as to seal the plenum layer 514 adjacent to the bottom filter layer 512. For example, the end plates 404 may be flat plates constructed so as to seal the open surface of the respective plenum layer 514. In configurations where a “double-thick” plenum layer is used, the plenum layer 514 at the end modules would only be single thickness, since there is no adjacent separation channel module at the end side. Thus, the end plates 404 may be constructed with appropriately sized recesses to provide supplemental fluid volumes such that the plenum layer at the end side has the same fluid volumes as the “double-thick” plenum layers.

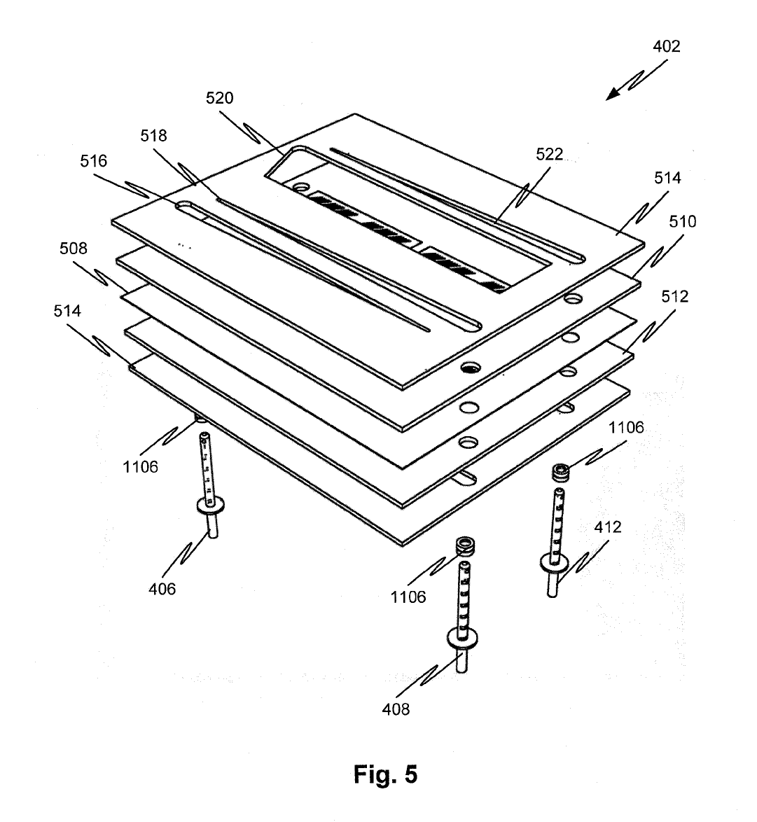

Referring now to FIGS. 5-8, the configuration and operation of a single separation module 402 in the multi-layered blood-separation module 400 is shown. The operation of the plenum layers 514, top filter layers 510, the bottom filter layers 512, and the shim layer 508 is similar to that described above with regard to FIGS. 2-3. 3. The shim layer 508 may be constructed such that a single separation channel is formed therein. In other configurations, more than one separation channel may be formed in each shim layer 508. For example, as shown in FIG. 6, each shim layer 508 may form two or more separation microchannels 530. Each separation microchannel 530 is arranged adjacent to but separate from the other separation microchannel 530. The separation microchannels 530 may each have independent inlets and outlets which connect to common lines in the plenum layer 514. Although two separation microchannels 530 have been illustrated, any number of separation microchannels 530 is possible in accordance with design requirements, such as flow rate, device size, and fabrication tolerances.

In operation, blood and sheath fluid are provided to each plenum layer 514 via inlet blood manifold 406 and inlet sheath manifold 408, respectively. The plenum layer 514 may be configured with a blood inlet line 516 and a sheath fluid inlet line 518. Blood entering blood inlet line 516 flows from an end 516a proximal to the manifold 406 to an end 516b distal from the manifold 406. As the blood flows in the blood inlet line 516 of the plenum layer 514, it is incident on one or more inlet slits 524 in the bottom filter layer 512. The blood may thus enter the separation channel 530 in shim layer 508 through respective slits 524 where it flows along the separation channel. Sheath fluid entering sheath fluid inlet lines 518 flows from an end 518a proximal to the manifold 408 to an end 518b distal from the manifold 408. As the sheath fluid flows in the sheath fluid inlet line 518 of the bottom plenum layer 514, it is incident on one or more inlet slits 526 in the bottom filter layer 512. Sheath fluid flow in the sheath fluid inlet line 518 of the top plenum layer 514 is also incident on one or more inlet slits 534 in the top filter layer 510. Thus, sheath fluid enters the separation channels 530 through slits in both the top filter layer 510 and the bottom layer 512, thereby sheathing the blood flow from the separation microchannel walls (i.e., the surfaces of the top and bottom filter layers) in the microchannels 530.

In general, the inlet slits in the filter layers 510, 512 may be sized and shaped to achieve laminar flow in the separation microchannel with no or a minimal number of stagnation regions. For example, the inlet slits for the blood flow and/or the sheath fluid flow may have parallel sidewalls through the thickness of the filter layers 510, 512. In another example, the inlet slits for the blood flow and/or the sheath fluid flow may be tapered in a thickness direction of the filter layers 510, 512. In still another example, the slits may be tapered in at least one of the thickness direction and the width direction of the filter layer. Of course, although only one slit is shown for each fluid inlet on each respective filter layer, more than one slit may also be employed. Further, other shapes and configurations are also possible for the fluid inlets in the respective filter layers.

Filters 532 are provided in the top filter layer 510 and filters 528 are provided in the bottom filter layer 512. Sheath flow adjacent to the top filter layer 510 in the separation microchannel 530 may exit the microchannel through the filter 532 and enter into the sheath flow outlet line 520 in the top plenum layer 514. Similarly, sheath flow adjacent to the bottom filter layer 512 in the separation microchannel 530 may exit the microchannel through the filter 528 and enter into the sheath flow outlet line 520 in the bottom plenum layer 514. The exiting sheath flow from both microchannels 530 in shim layer 508 may be combined in the sheath flow outlet line 520 in the plenum layer 514. Sheath fluid collected in the sheath flow outlet line progresses from an end 520a distal from the manifold 410 to an end 520b proximal to the manifold 410, whereby the collected sheath fluid is conveyed by manifold 410 out of the plenum layer 514.

The top filter layer 510 may include a blood outlet slit 536, by which the remaining blood flow in the separation channel 530 exits therefrom into the blood outlet line 522 of the plenum layer 514. The exiting blood flow from both microchannels 530 in shim layer 508 may be combined in the blood outlet line 522 in the plenum layer 514. Blood collected in the blood outlet line 522 through slit 536 progresses from an end 522a distal from the manifold 412 to an end 522b proximal to the manifold, whereby the collected blood is conveyed by manifold 412 out of the plenum layer 514.

In general, the blood outlet slits in the filter layer 510 (or alternately in filter layer 512) may be sized and shaped to achieve laminar flow in the separation microchannel with no or a minimal number of stagnation regions. For example, the outlet slit for the blood flow may have parallel sidewalls through the thickness of the filter layer. In another example, the outlet slit for the blood flow may be tapered in a thickness direction of the filter layer. In still another example, the outlet slit may be tapered in at least one of the thickness direction and the width direction of the filter layer. Of course, although only one slit is shown for each blood outlet on the top filter layer 510, more than one slit may also be employed. Further, other shapes and configurations are also possible for the fluid outlets in the respective filter layers.

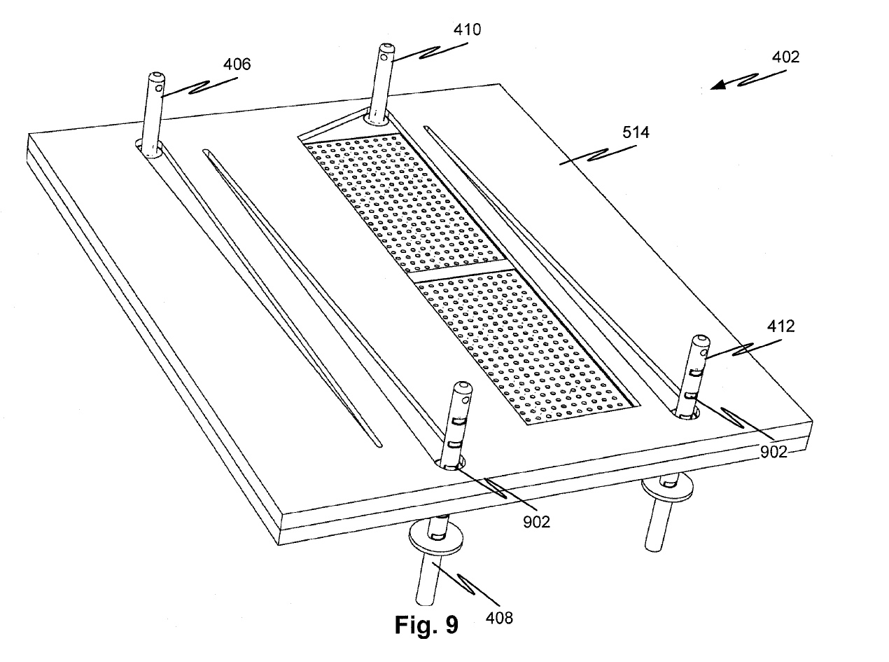

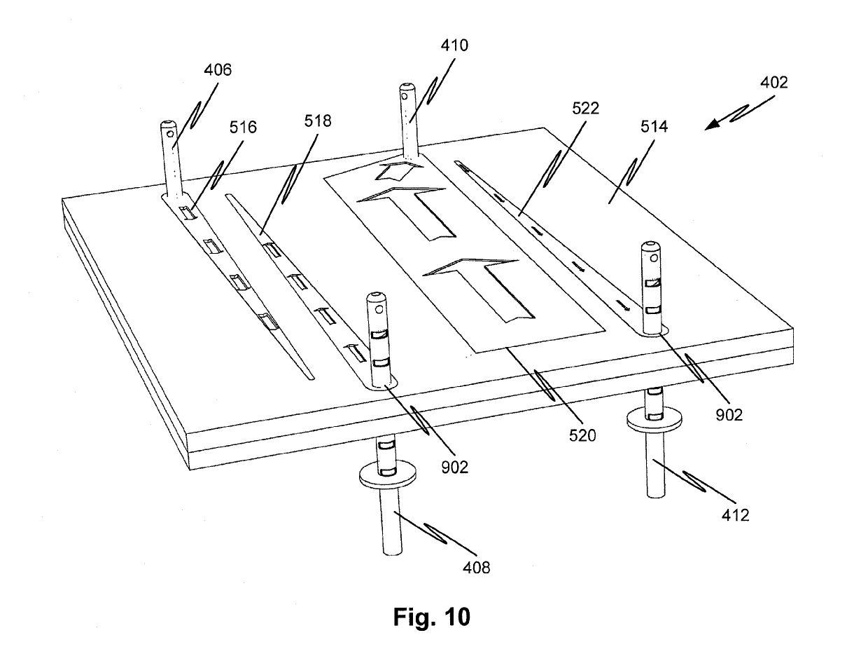

Referring now to FIGS. 9-10, aligned holes 538 are provided in each of top filter layer 510, shim layer 508, and bottom filter layer 512 such that appropriate fluids can be provided to each plenum layer. Manifolds may be designed and arranged with respect to the inlet and outlet lines of the plenum layer 514 so as to reduce and/or eliminate any potential stagnation regions within the blood-plasma separation module 400. The manifolds thus extend through the holes in each layer and seal thereto. Each of the manifolds 406, 408, 410, and 412 may be provided with openings 902 precisely arranged so as to align with the appropriate inlet or outlet line of each plenum layer 514 when the manifolds are fully inserted into the blood-plasma separation module 400. For example, when dealing with five separation modules 402 in a blood-plasma separation module 400, each manifold may have six openings 902, corresponding to the six plenum layers 514 in the blood-plasma separation module 400. Each manifold can be appropriately sized and shaped to provide a relatively smooth wall surface for the flows therein, in particular, the blood flows.

Manifolds 406, 408, 410, and 412 may be eliminated if smooth surfaces can be created for holes 538. The aligned holes 538 may form a smooth fluid passage and thus serve, in effect, as the manifold distributing fluid to the various layers. Appropriate inlet and outlet connections may be provided to convey fluid to the fluid passage formed in by the holes 538. In such a case, each layer may be appropriately redesigned to have flow channel features that prevent, or at least reduce the number of, stagnation regions in the fluid flows. For example, holes 538 can be machined and coated, before or after stacking of the various layers, to provide a smooth fluid pathway connecting the multiple plenum layers.

In another example, the various layers forming the blood-plasma separation device 400 can be assembled together, after which the various holes 538 can be precision machined to form a smooth fluid pathway connecting the multiple plenum layers. Such precision machining may include, but is not limited to, laser machining and semiconductor manufacturing techniques.

The inlet manifolds are arranged such that the openings 902 point away from the length of the respective inlet line. For example, as shown in FIG. 10, the sheath fluid inlet manifold 408 has an opening 902 which points away from the length of the sheath fluid inlet line 518. As the sheath fluid exits through opening 902 of the manifold 408, the sheath fluid is forced to wrap around the manifold before proceeding down the length of the sheath fluid inlet line 518. The sheath fluid inlet line 518 in the area around the manifold 408 may be rounded so as to minimize any potential stagnation regions. The sheath fluid inlet line 518 may also be tapered to allow for reduced sheath fluid flow volume at the distal end 518b of the sheath fluid inlet line 518.

Similarly, the blood inlet manifold 406 has an opening which points away from the length of the blood inlet line 516. As the blood exits through the opening of the manifold 406, the blood is forced to wrap around the manifold before proceeding down the length of the blood inlet line 516. The blood inlet line 516 in the area around the manifold 406 may be rounded so as to minimize any potential stagnation regions. The blood inlet line 516 may also be tapered to allow for reduced blood volume at the distal end 516b of the blood inlet line 516. The opening slits in the manifold may be smaller than the height of the plenum. Alternatively the manifold may be formed such that their width is the same as the plenum height. The coating described above may be used to ameliorate sharp edges or imperfections in the matching of the opening to the surfaces of the plenums.

The outlet manifolds are also arranged such that the openings 902 of each manifold points away from the central area of the respective outlet line. For example, as shown in FIG. 10, the sheath fluid outlet manifold 410 has an opening which faces a proximal end 520b of the sheath fluid outlet line 520. As the sheath fluid enters the plenum layer 514 through filters 528 and 534, it fills the sheath fluid outlet line 520 and proceeds to the opening in sheath fluid outlet manifold 410. Because of the orientation of the opening in the outlet manifold 410, the exiting sheath fluid is forced to wrap around the manifold 410 before entering the opening of the manifold 410. The sheath fluid outlet line 520 in the area around the manifold 410 may be rounded so as to minimize any potential stagnation regions.

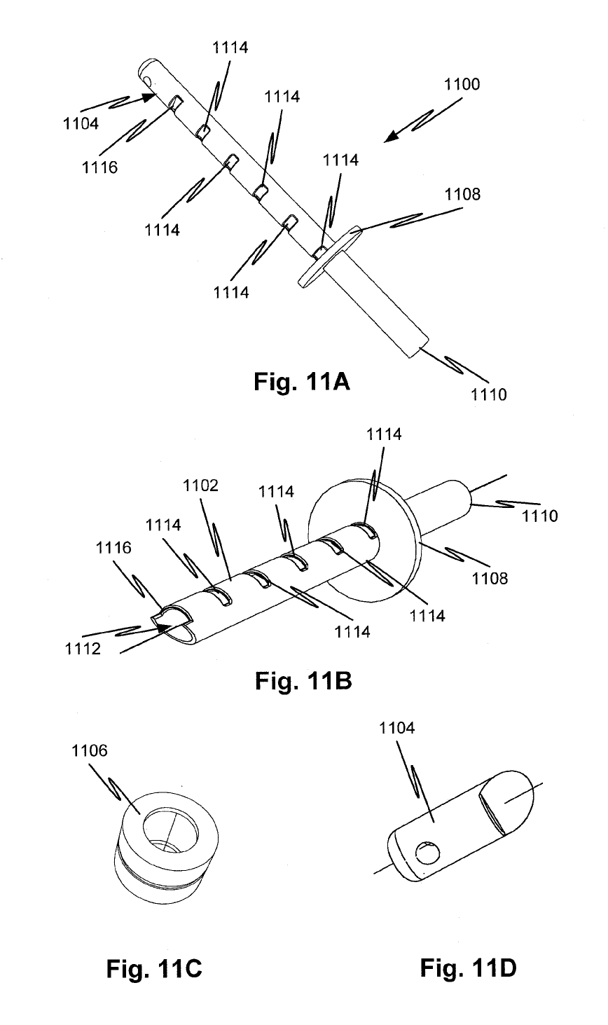

Similarly, the blood outlet manifold 412 has an opening which points away from the length of the blood outlet line 522. As the blood enters the plenum layer 512 through slit 536 in the top filter layer 510, it fills the blood outlet line 522 and proceeds to the opening 902 in the outlet manifold 412. Because of the orientation of the opening in the outlet manifold 412, the exiting blood is forced to wrap around the manifold 412 before entering the opening of the manifold 412. The blood outlet line 522 in the area around the manifold 412 may be rounded so as to minimize any potential stagnation regions. The blood outlet line 522 may also be tapered to allow for increased blood volume at the proximal end 522b of the blood outlet line 522. Referring now to FIGS. 11A-11D, close-up views of various components of an exemplary manifold 1100 is shown. Note that the manifold 1100 may be used as one or more of manifolds 406, 408, 410, and 412, illustrated in FIGS. 4-10. Manifold 1100 may include a body portion 1102 and an end cap portion 1104. Body portion 1102 has a fluid pathway 1112 extending therethrough and communicating with a port 1110 at an end thereof. Fluid may be introduced to or removed from fluid pathway 1112 by way of the port 1110. An end cap 1104 may be mounted to the body portion 1102 at an end of the manifold 1100 distal from the port 1110, such that fluid in the fluid pathway may only exit or enter the manifold through port 1110 or openings along the surface of the body portion 1102. A grommet 1106 may be provided to seal the manifold 1100 against the filter layer 510. The grommet may be of Teflon, elastomer, or any suitable material. The manifold may also be constructed with appropriate design of end caps and fluid inlets/outlets such that stasis is reduced and/or minimized and fiber clots may be avoided.

All openings between adjacent layers, such as the openings that define the separation channels and the openings that define the plenums, may be sealed by any suitable mechanism. For example, a gasket ridge may be printed around each opening to concentrate pressure and form a seal. A frame constructed around the stack of plates may be used to provide such a compression seal. Instead of a structured clamping frame, potting material be molded to an outside of the layers and cured under compression to ensure a seal. Also, instead of a manifold, the openings may be sealed between adjacent plates so as to form effectively the same device without a separate manifold component. In all embodiments, the number of edges that may cause fluid acceleration, particularly blood, may be minimized to reduce the risk of thrombogenesis.

Openings 1114 may be provided in the surface of the body portion 1102 and communicating with the interior fluid pathway 1112. The final opening 1116 in the manifold 1100 may be formed by fitting and sealing the end cap 1104 to the body portion 1102, such that the bottom and sides of the opening 1116 is formed by the body portion 1102 and the top of the opening 1116 is formed by the end cap 1104. The openings 1114 and 1116 may be precision machined at locations that are precisely aligned with the respective input or output lines of the plenum layer 514.

An annular protrusion 1108 may be provided on an exterior surface of the body portion 1102. This annular protrusion 1108 may serve to align openings 1114 and 1116 with respective inlet or outlet lines of the plenum layers in the blood-plasma separation module 400 by sampling abutting the protrusion 1108 with a bottom surface of the blood-plasma separation module 400. Of course, other mechanisms for alignment are also possible according to one or more contemplated embodiments.

The blood-plasma separation device 400 may be constructed so as to minimize device size while providing precision control of device size and alignment. For example, holes 538 may be provided in the filter layers 510, 512 and the shim layer 508 so as to provide alignment therebetween. Holes 538 also serve as access points through which manifolds are inserted and interface with respective inlet and outlet lines in the plenum layer 514. Moreover, the configuration of the blood-plasma separation device 400 is such that the number of layers and overall device size can be minimized, or arranged, so as to provide the desired fluid distribution functions to each separation microchannel and to handle the desired blood flow rates in a compact size. The blood-plasma separation device 400 may be sized so as to be portable and/or preferably wearable by a patient. Contemplated embodiments of the blood-plasma separation device 400 can also provide for an assembly process with a minimal number of parts and assembly steps.

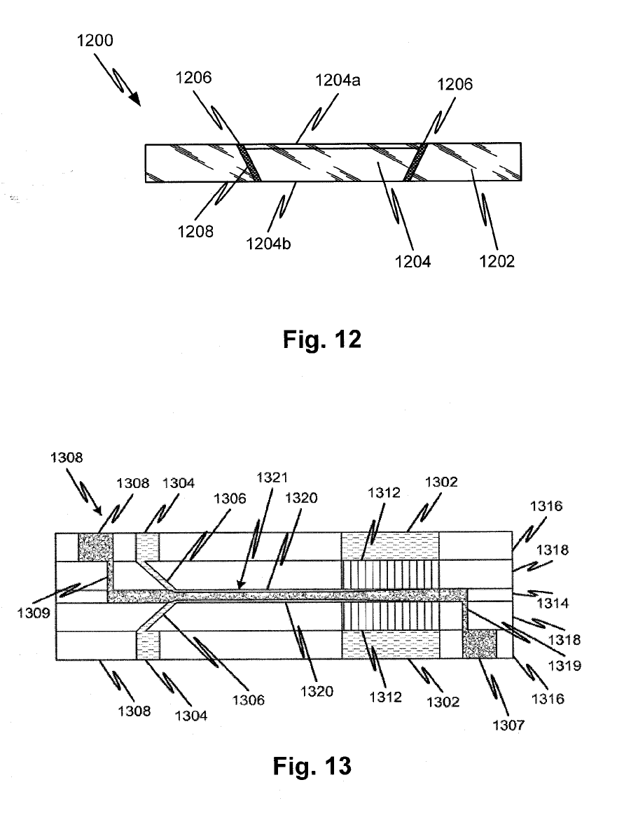

For example, referring to FIG. 12, a filter layer 1200 has a base plate 1202 with a slanted recess 1208. A prefabricated filter chip 1204 may be arranged within the slanted recess 1208. The filter chip 1204 may have a separation channel side 1204a and a filtrate side 1204b. The filter chip 1204 may be arranged within the slanted recess 1208 with a frit 1206. The filter layer 1200 may then be subjected to a heat treatment such that frit 1206 bonds the filter chip 1204 to the base plate 1202 without any melting of the base plate 1202 or the filter chip 1204. For example, base plate 1202 may be a glass plate while filter chip 1204 may be made from silicon or silicon nitride. The frit 1206 may be formed from glass, ceramic, metal, and/or other materials with suitable properties so as to form a bond, and fill any gap, between the filter layer 1202 and filter chip 1204 by heating. The heat treatment may be at a temperature below the glass transition temperature of the glass plate but above the melting temperature of the frit 1206, thereby bonding the filter chip to the base plate 1202. Before or after the bonding of the filter chip to the base plate 1202, slits may be formed at appropriate locations within in the base plate to serve as inlet or outlet slits for a filter layer. The features of the filter layer may be formed within the glass plate by any suitable means, such as, but not limited to, microfabrication or laser machining or etching.

Moreover, various layers may be combined to minimize fabrication steps of the complete device. A top filter layer 510, a plenum layer 514, and a bottom filter layer 512 may be combined into a single unit. The plenum layer 514 may formed from a glass plate of an appropriate thickness, for example, 300 μm thick. The top and bottom filter layers 510, 512 may also be formed from a glass plate or silicon plate which may have integral nanoport filters. The plenum layer 514 may be sandwiched between the top and bottom filter layers 510, 512 and appropriately aligned, after which the layers may be joined together via anodic bonding or any other technique which strengthens the overall combined unit. The resulting combined filter/plenum layer may be assembled with shim layers, made of glass, steel or formed by etching, machining or buildup in the filter layer, and other combined filter/plenum layers to form one or more separation modules 402 of the blood-plasma separation device 400.

The shim layer 508 may also be formed from a glass plate of an appropriate thickness, for example, 80 μm thick. The features defining the microchannel 530 may be formed within the glass plate by any suitable means, such as, but not limited to, microfabrication or laser machining. A polymer coating may be applied to the surfaces of the top filter layer 510 and the bottom filter layer 512 adjacent to the shim layer 508. The shim layer 508 may thus be sandwiched between the top filter layer 510 and the bottom filter layer 512, with the polymer coating serving to bond the shim layer with the surfaces of the filter layers.

In other embodiments, other processes for sealing and securing the various layers to each other are used. For example, optical contact bonding may be used to bond the layers together. In such a process, the surface of each layer may be highly polished and then brought into contact, whereby intermolecular forces bond the two layers together.

After assembly of the various layers of the blood-plasma separation module 400, the manifolds may be installed through the holes 538 in the shim and filter layers and respective lines 516, 518, 520, and 522 in the plenum layers. The device may be compressed to bring the manifold openings 902 into alignment with the respective lines of the plenum layers 514 and to further bond the shim layer 508 to the adjacent filter layers. After compression, a potting material may be applied to the exterior of the entire blood-plasma separation module 400 so as to seal the device from the environment.

Referring to FIG. 13, a layer of a blood plasma separation device 1308 has a blood inlet plenum 1308 in a plenum layer which feeds an inlet slit 1309 in a flow control layer (or filter layer) 1318. Blood flows into a shim layer 1314 and exits an outlet slit 1319 in a flow control layer (or filter layer) 1318 and finally exits the device 1308 via a blood outlet plenum 1307. Sheath fluid enters a sheath fluid plenum 1304 and is conveyed into separation channel 1321 via an angled slit 1306. Sheath fluid exits the channel 1321 through a wall filter 1312 and flows into a sheath fluid exit plenum 1320 out of the module. The blood is thus sheathed by sheath layer 1320 as in prior embodiments. However, in the present embodiment, the angled inlet slits 1306 may allow a smoother merging of sheath fluid into the separation channel 1321 than embodiments in which the inlet slit is perpendicular to the channel 1321 and the flow direction of the blood therethrough.

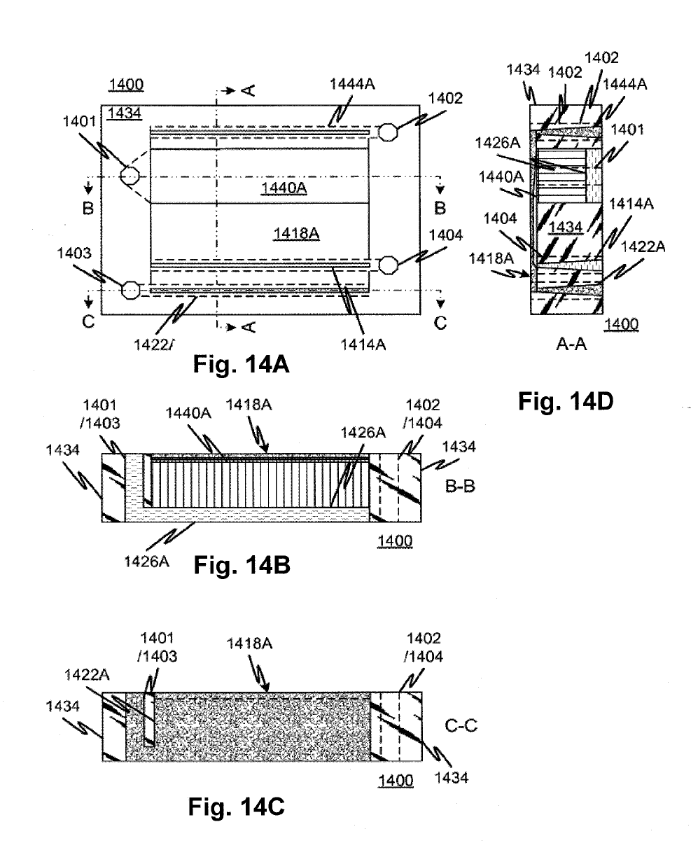

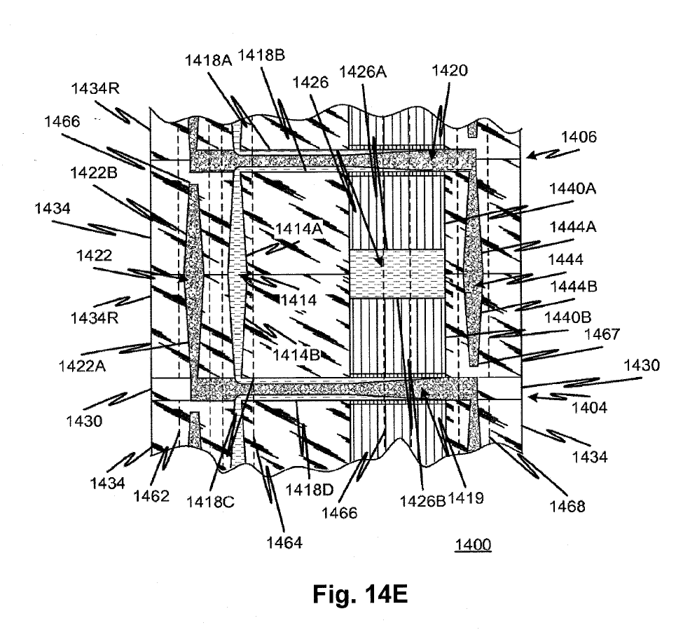

Referring to FIGS. 14A through 14E, blood plasma separation module 1400 provides flow control slits and filters in a same flow distribution layer 1418A as provides the function of the plenums for distribution of sheath fluid and blood. Manifolds 1462, 1464, 1466, and 1468 are provided by adjacent polygonal openings 1401 1402, 1403, and 1404 in adjacent flow distribution layers (e.g., 1434). Manifold 1462 supplies blood to tapered channels 1422A (also 1422B which is in an adjacent mirror image flow distribution layer 1434R). Tapered channels 1422A and 1422B form a distribution channel 1422 that conveys blood across the width of the separation channel 1420 which is formed by overlapping recesses 1418A and 1418B (also separation channel 1419 formed by adjacent recesses 1418C and 1418D).

Manifold 1464 supplies blood to tapered channels 1414A (also 1414B which is in the adjacent mirror image flow distribution layer 1434R). Tapered channels 1414A and 1414B form a distribution channel 1414 that conveys sheath fluid across the width of the separation channel 1420. Manifold 1468 conveys blood leaving the separation channels 1419 and 1420 from tapered channels 1444A (also 1444B which is in the adjacent mirror image flow distribution layer 1434R). Tapered channels 1444A and 1444B form a distribution channel 1444 that conveys blood fluid from across the width of the separation channel 1420 (1419).

A nanopore filter 1440A is provided in each of the flow distribution layers 1434 in an arrangement similar to that of the above embodiments. A plenum 1426 for uptake of withdrawn sheath fluid is formed by adjacent opposing recesses 1426A and 1426B in flow distribution layers 1434 and 1434R.

As can be seen best in FIG. 14A, the plenums 1422, 1414, 1426, and 1444 all convey fluid into respective manifolds 1462, 1464, 1466, and 1468. Thus, each of the plenums 1422, 1414, 1426, and 1444 extend laterally to a respective manifold 1403, 1404, 1401, and 1402. Note that FIGS. 14B through 14D are respective sections taken by section lines indicated in FIG. 14A. Note that the recess 1422B has a blind end 1466 (and similarly the plenum 1444B has a blind end 1467 so that each separation channel 1420 has a single blood inlet and a single blood outlet. The blind ends can be eliminated in an alternative embodiment so that there are two blood inlets and outlets for each separation channel.

The tapering of the channels 1422A, 1414A, and 1444A (and similar instances in other layers) provides space for low flow resistance distribution of fluid (blood or sheath fluid) and restriction of flow to provide for equalization of the flow. The precise shapes of the channels may be a wedge shaped channel or some variation thereof. An optimal design would provide for equalized flow across the fluid inlets to the separation channels. In alternative embodiments, the tapered channels may be tapered on both sides of the flow distribution layers 1434 (1434R) so that a minimal width flow restriction exists between the opposite faces of the flow distribution layer 1434. The three-dimensional shapes of the flow distribution layers may be formed by lithographic techniques. Filters (e.g., 1440A) may be formed by the same technique and made integral to the flow distribution layers 1434.

A shim layer may or may not be used to provide the separation channel 1420 as indicated at 1404 (1406 showing a separation channel formed by recesses 1418A-1418D) in a flow distribution layer 1434. Note that the embodiments of FIGS. 14A through 14D have recesses 1418A to form the flow channels as indicated at 1406, but a variation of these embodiments results by the elimination of the recess 1418A, which would be used with a shim layer 1430 to provide a separation channel as illustrated at 1404.

The embodiments of FIGS. 14A through 14E may allow the construction of a sheathing device consisting of an arbitrary number of separation channels in which each channel requires only two wall layers; or three wall layers where a shim layer is used. This reduces the component count over embodiments in which four layers are provided. In the 14A through 14E embodiments, adjacent pairs of wall layers define the separation channel employing recess features of one side of each member of the pair while recess features on an opposite side are used to define distribution channels. The filter is embedded at an appropriate position in the wall layer such that the separation channels and distribution channels are provided for.

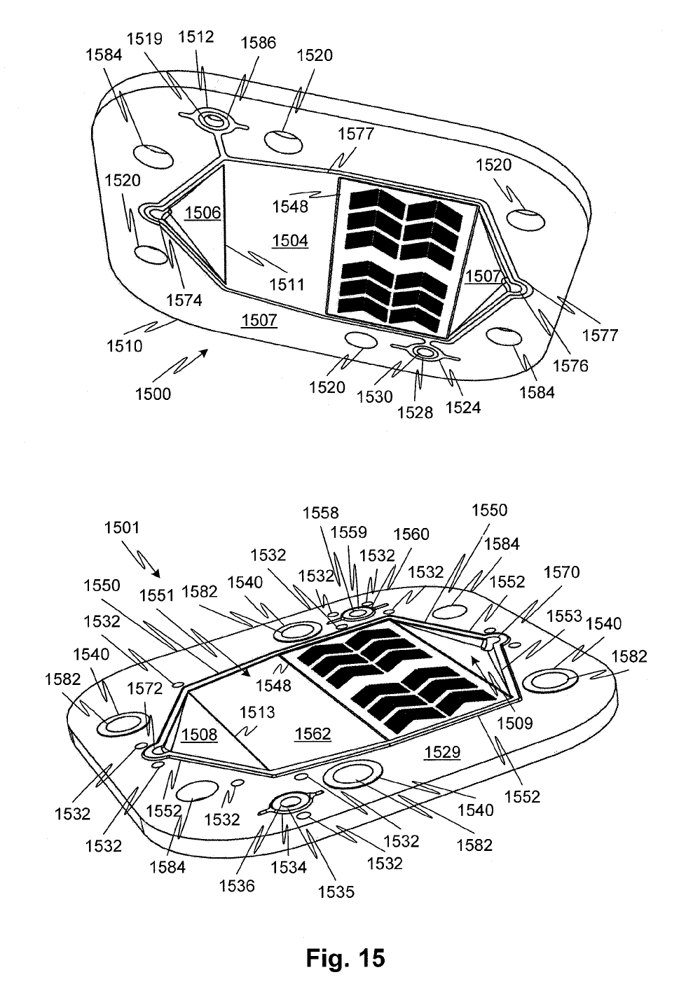

Referring to FIG. 15, a flow distribution channel member 1500 mates with a flow distribution and microfluidic separation channel member 1501 to form a microfluidic separation channel and inlet and outlet blood flow plenums between them. When the members 1500 and 1501 are pressed against one another, the inlet blood plenum is a tapered volume enclosed between surfaces 1506 and 1508. At that time, also, the inlet blood plenum is a tapered volume enclosed between surfaces 1507 and 1509. A thin microfluidic separation channel is also enclosed between surfaces 1504 and 1562 and also between respective ones of outlet filters 1548. Blood is delivered to the to the inlet blood plenum via a header formed by channel segments 1574 and 1571 that are stacked up by the stacking of multiple adjacent flow distribution channel members 1500 mates with flow distribution and microfluidic separation channel members 1501. Similarly blood is recovered from the outlet blood plenum via a header formed by channel segments 1576 and 1570, are aligned and extended by the stacking of multiple adjacent flow distribution channel and microfluidic separation channel members 1500 and 1501, mates with flow distribution and microfluidic separation channel members 1500 and 1501. The microporous filters 1548 form parallel and opposite walls of the microfluidic separation channel flow channel and span a substantial fraction of the length thereof. In embodiments, the microporous filters 1548 span between 25 and 75 percent of the microfluidic separation channel length. In other embodiments, they span about half the microfluidic separation channel length.

Sheath fluid inlet headers are formed by stacks of openings 1519 and 1586 which form header channels and open to respective plenums (not shown in the present drawing) and enter the sheath channel through narrow slits 1511 and 1513. Sheath fluid outlet headers are formed by stacks of openings 1558 and 1530 which form header channels and open to respective plenums underneath the microporous filters (not shown in the present drawing) which collect sheath fluid from the microfluidic separation channel via the microporous filters 1548.

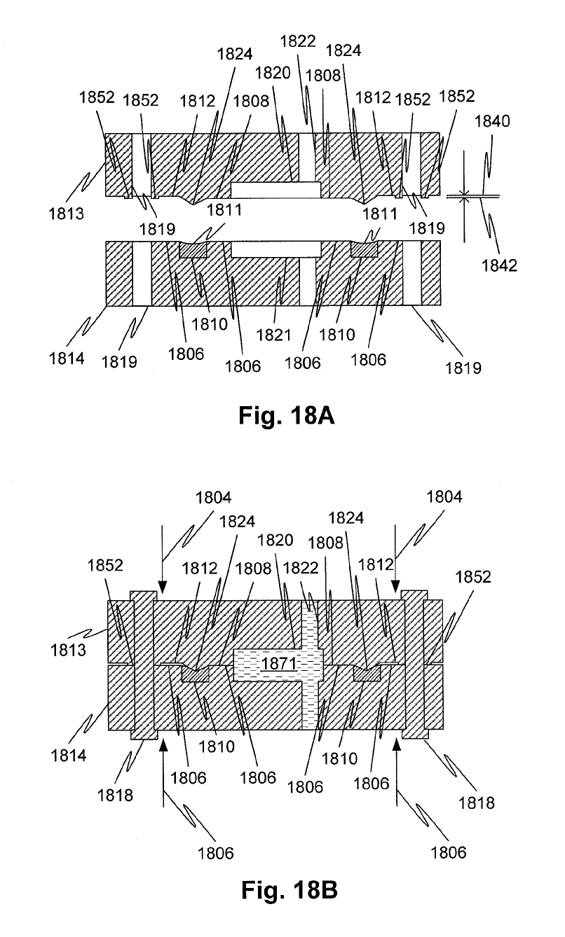

The openings 1530 and 1558 are sealed by the mating of a land surface 1559 with a surface 1528. The surface 1528 is coplanar with the plane of the surface 1507 of a flow distribution channel member 1500. The land surface 1559 is elevated slightly above the surface 1529 of the microfluidic separation channel member 1501. A secondary seal is formed by the mating of a raised ridge 1560 which compresses an elastomer-filled channel 1524. The features of this seal, which is provided elsewhere in the current embodiments, is now described with reference to FIGS. 18A and 18B.

Referring now to FIGS. 18A and 18B, a raised ridge 1824 surrounds a well 1820 which mates with a well 1821 to enclose a volume 1871 therebetween. One or more fluids may enter or leave the volume though one or more channels such as indicated at 1822 formed in one or both of the members 1813 and 1814. Members 1813 and 1814 may represent any of the module members described in the present application and they are described features of the embodiments of FIGS. 15-17. Fastener openings 1819 are provided to allow member 1813 and 1814 to held and pressed together (the force of urging being indicated by opposing arrows 1804 and 1806) to seal the volume 1871 by suitable fasteners as illustrated at 1818. Fasteners 1818 may be, for example, bolts or rivets. Guide pins (not shown in the current drawing) may also be provided to facilitate alignment and assembly.

The ridge 1824 compresses an elastomer 1811 that partially fills a channel 1810. The quantity of the elastomer is such that the volume displaced by the penetration of the of the ridge 1824 as the members 1813 and 1814 are brought together and pressed together just barely is such that no elastomer is forced between the mating surfaces 1808 and 1806.

Surfaces 1808 lie in a plane 1842 while the remainder of the facing surface of member 1813 lies in a plane 1840. Thus, surfaces 1808 are slightly elevated from the main surface 1812 of the member 1813. Also, lands 1852 are provided proximate fastener openings 1819 and the lands 1852 have surfaces that are in the same elevated plane 1842. As a result of the structure shown, the volume 1871 is sealed by the direct compression of surfaces 1808 and 1806, which are preferably polished flat with a back-up seal provided by the elastomer 1811 and ridge 1824. The lands 1852 surrounding the fastener openings 1819 prevent the creation of any distortion inducing moments in the members 1813 and 1814 while permitting much of the force applied by the fasteners 1818 to be applied to the seals between land surfaces 1808 and opposite surfaces 1806 to form seals.

In an alternative embodiment, the elastomer 1811 may protrude from the channel 1810 forming a bead and the ridge 1824 may be reduced, omitted, or replaced by a recess. The embodiment of FIGS. 18A and 18B are a generalized embodiment of a sealing structure that may be used with any of the embodiments discussed herein. Although only two members 1813 and 1814 are shown, a stack including many members may be provided as discussed respective to the various embodiments disclosed herein, may be provided and all of them compressed together with a single set of fasteners.

Returning now to FIG. 15, the openings 1536 and 1519 are sealed by the mating of a land surface 1535 with an opposing surface 1586. The surface 1586 is coplanar with the plane of the surface 1507 of a flow distribution channel member 1500. The opening 1536 forms a channel with the opening 1519 to convey and distribute sheath fluid to and among the distribution 1500 and separation channel 1501 members. The land surface 1535 is elevated slightly above the surface 1529 of the microfluidic separation channel member 1501. A secondary seal is formed by the mating of a raised ridge 1534 which compresses an elastomer-filled channel 1512. The features of this seal, which is provided elsewhere in the current embodiments, is as described above with reference to FIGS. 18A and 18B.

A well 1551 formed in microfluidic separation channel member 1501 has a perimeter seal of the structure of FIGS. 18A and 18B which circumnavigates the microporous wall filters 1548, blood inlet 1572 and outlet 1570 header openings, and blood supply 1508 and removal 1509 plenums. The perimeter seal includes a raised ridge 1550 and a land surface 1553 adjacent the well 1551. The surface 1577 is pressed directly against the land surface 1553 to seal a volume that forms the microfluidic exchange channel. The land surface 1553 is raised slightly above the main surface 1529 of the microfluidic separation channel member 1501. A channel filled with elastomer 1577 circumnavigates the area of the well 1551 and forms a secondary seal with the raised ridge 1534 when the flow distribution and microfluidic separation channel members 1500 and 1501 are brought together.

Locator pin openings 1584 may be provided to facilitate alignment and assembly of the flow distribution and microfluidic separation channel members 1500 and 1501. The locator pins may extend through as many layers of the distribution and microfluidic separation channel members 1500 and 1501 as desired. Fastener openings 1582 are provided with lands 1540 as described with reference to FIGS. 18A and 18B. Ports 1532 are provided to permit the injection of elastomer (prior to hardening or polymerization) into the channels on an opposite face of the microfluidic separation channel member 1501.

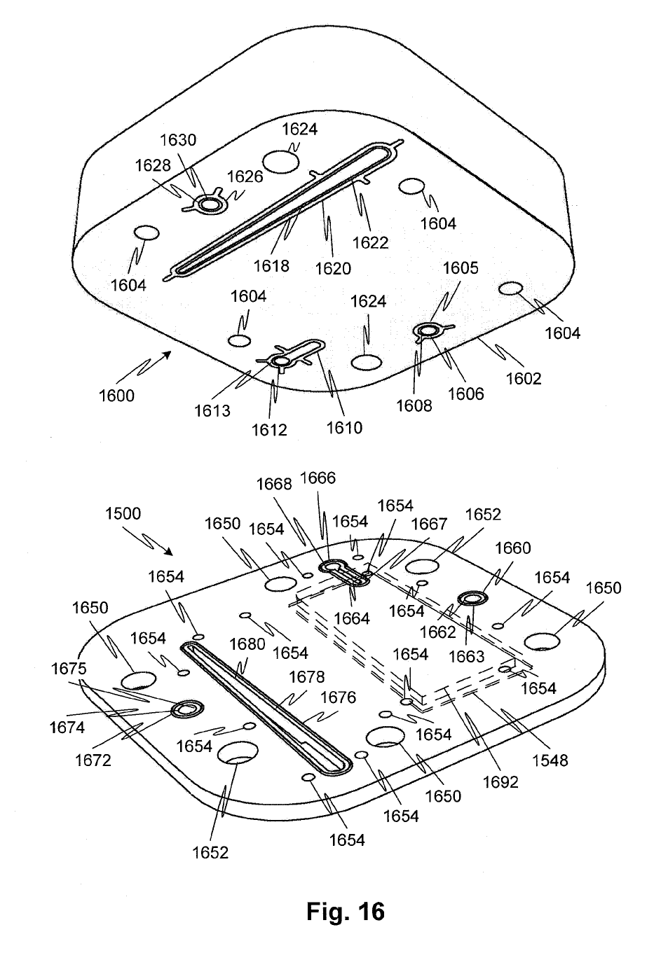

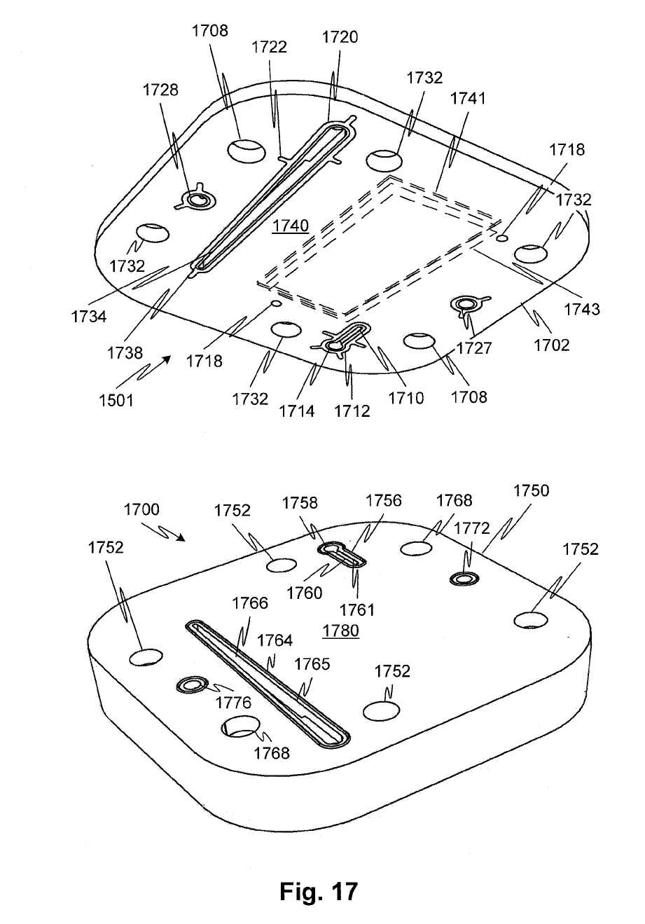

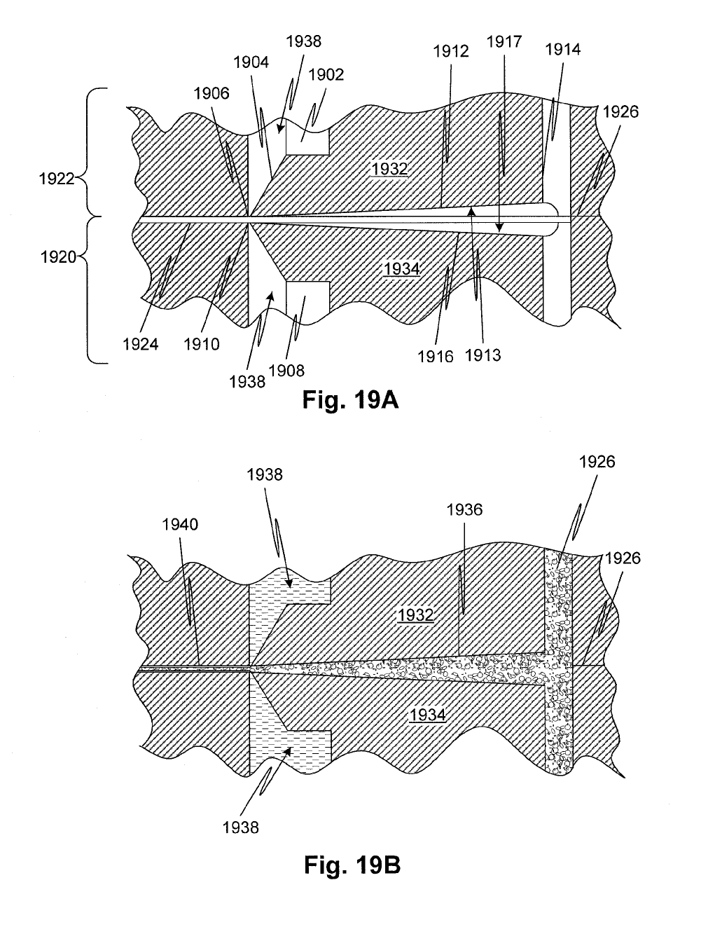

FIGS. 19A and 19B illustrate how the blood supply plenum is formed between wells 1506 and 1508 of FIG. 15, and how the slits 1511 as well as sheath fluid supply plenums are formed and inject sheath fluid into the microfluidic separation channel. The sheath fluid supply plenums are formed in sides of the flow distribution and microfluidic separation channel members 1500 and 1501 that are opposite those shown in FIG. 15 and are discussed below with reference to FIGS. 16 and 17, respectively.

Surfaces 1912 and 1916 are facing surfaces at the bottom of wells 1913 and 1917 formed in members 1922 and 1920, respectively. Together the wells enclose a plenum volume when the members 1922 and 1920 are brought together. A recess 1924 in the member 1020 creates a microfluidic separation channel 1940. Sheath fluid plenums 1938 formed in each of the members 1920 and 1922 taper along a length that goes into the page of the drawing and also have a section that tapers to a small slit 1906 in member 1922 (1910 in member 1920). Blood flows into the header 1926 and is distributed into each of one or multiple blood plenums 1936. The slits 1906 and 1910 inject sheath fluid into the blood forming a layered flow in the microfluidic separation channel 1940.

Referring to FIG. 16 as well as FIG. 15, an end block 1600 forms sheath fluid distribution and receiving channels with a surface of the distribution member 1500 on the opposite side of the side previously discussed with reference to FIG. 15. In FIG. 16, the distribution member 1500 is shown from the opposite side showing features that cause sheath fluid to be distributed to the small slit 1511 and which remove the sheath fluid from a plenum 1692 residing beneath the microporous filters 1548. The plenum 1692 is shown by the dotted lines and is created by a well in the distribution member 1500 and the microporous filter 1548. This plenum opens to the groove 1664 formed in the distribution member 1500 allowing sheath fluid to reach the groove 1668 which is in communication with opening 1558. A tapered recess 1618 in the end block 1600 is shaped similarly to a tapered recess 1680 in distribution member 1500. When the end block 1600 and the distribution member 1500 are brought together, these recesses 1618 and 1680 form a plenum such that sheath fluid conveyed through the opening 1536 and 1519 flows into the plenum and then through the slit 1511 into the separation channel. The tapering of the channel is the same as the taper referred to as extending into the page of the drawing in the discussion of FIGS. 19A and 19B. At the bottom of the recess 1680, a tapering perpendicular to the former, and located at the bottom of the well, extends toward the slit 1511, as discussed with reference to FIGS. 19A and 19B.

The plenum formed by recesses 1618 and 1680 are sealed by polished surfaces of a land 1678 and a surrounding surface 1622. This seal is backed up by a channel filled with elastomer 1620 into which a ridge 1676 is urged as described. Similarly, the groove 1664 is closed and sheath fluid outlet opening 1668 is sealed to sheath fluid outlet opening 1613 by a circumnavigating land surface 1666 which is urged against an opposite surface 1612 and backed up by a ridge 1667 and elastomer filled channel 1610 as discussed. Blood outlet header opening 1662 is sealed to blood outlet header opening 1606 by means of a land surface 1663 that mates with a surface 1608. This seal is backed up by the seal formed by a ridge 1660 that engages an elastomer filled channel 1605. Blood inlet header opening 1630 is sealed to blood inlet header opening 1674 by means of a land surface 1675 which mates with a surface 1628. This seal is backed up by the seal formed by a ridge 1672 which engages an elastomer filled channel 1626.

Preferably, the end block is stiffer than the distribution and microfluidic separation channel members 1500 and 1501 in order to provide predictable and firm pressure to form all the seals.

Locator pin openings 1652 and 1624 may be provided to facilitate alignment and assembly of the flow distribution 1500 and end block 1600 members. Fastener openings 1650 and 1604 are provided to hold the members together. Ports 1654 are provided to permit the injection of elastomer (prior to hardening or polymerization) into the channels on the opposite face of the microfluidic separation channel member 1500.

Referring now to FIG. 17 as well as FIG. 15, an end block 1700 forms sheath fluid distribution and receiving channels with a surface of the distribution and separation channel member 1501 on the opposite side of the side previously discussed with reference to FIG. 15. In FIG. 17, the distribution and separation channel member 1501 is shown from the opposite side showing features that cause sheath fluid to be distributed to the small slit 1513 and which remove the extraction fluid from a plenum 1741 residing beneath the microporous filters 1743. The plenum 1741 is shown by the dotted lines and is created by a well in the distribution member 1501 and the microporous filter 1548 (and indicated at 1741). This plenum opens to the groove 1710 formed in the distribution and separation channel member 1501 allowing sheath fluid to reach the groove 1710 which is in communication with opening 1714. A tapered recess 1766 in the end block 1700 is shaped similarly to a tapered recess 1734 in distribution and separation channel member 1501. When the end block 1700 and the distribution and separation channel member 1501 are brought together, these recesses 1734 and 1766 form a plenum such that sheath fluid conveyed through the opening 1714 and 1728 flows into the plenum and then through the slit 1513 into the separation channel. The tapering of the channel is the same as the taper referred to as extending into the page of the drawing in the discussion of FIGS. 19A and 19B. At the bottom of the recess 1734, a tapering perpendicular to the former, and located at the bottom of the recess, extends toward the slit 1513, as discussed with reference to FIGS. 19A and 19B.

The plenum formed by recesses 1734 and 1766 are sealed by polished surfaces of a land 1765 and a surrounding surface 1738. This seal is backed up by a channel filled with elastomer 1720 into which a ridge 1764 is urged as described. Similarly, the groove 1760 is closed and sheath fluid outlet opening 1758 is sealed to sheath fluid outlet opening 1714 by a circumnavigating land surface 1761 which is urged against an opposite surface 1710 and backed up by a ridge 1756 and elastomer filled channel 1756 as discussed. Blood outlet header opening 1727 is sealed to blood outlet header opening 1772 using similar structure as is blood inlet header opening 1732 sealed to blood inlet header opening 1776.

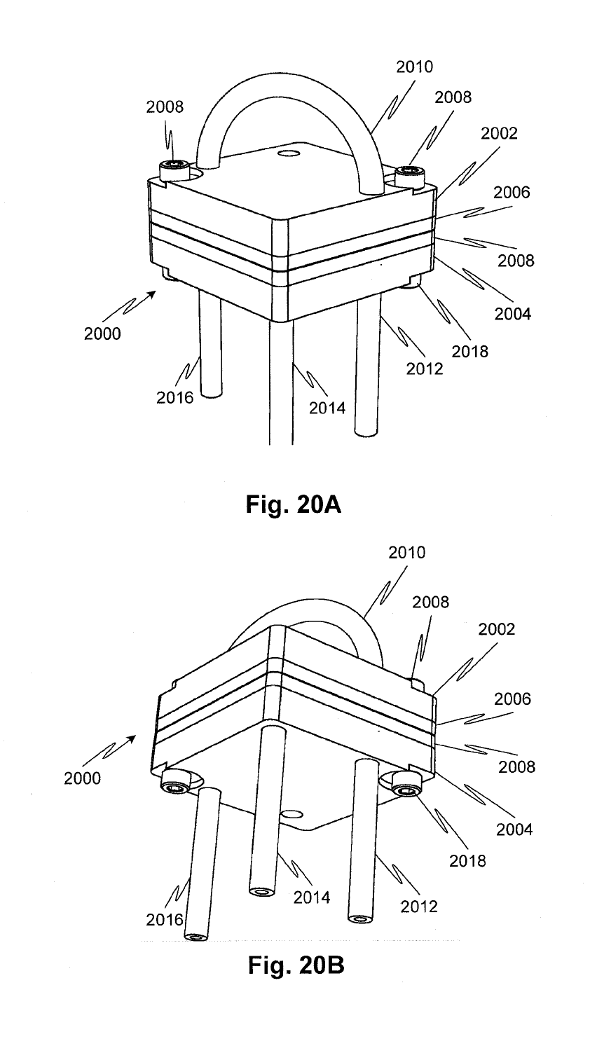

Referring now to FIGS. 20A and 20B, a separation module, in an embodiment, a blood plasma separation module 2000 is shown in from upper and lower angles of view. End plates 2002 and 2004 are bolted together to press intermediate plates 2006 and 2008 together to form sealed channels (not shown in the present figures) as described further below and with seal and other details as in FIGS. 15 through 18B. The intermediate plates 2006 and 2007 form a single separation channel, but any number of additional plates can be added to the structure to form a larger number of separation channels. A sample fluid supply line 2016 and a sample fluid return line 2012 are shown. An extract line 2014 is also shown. In embodiments, blood is pumped through the supply line 2016, enters the channel (or channels) and exits the return line 2012 while blood plasma exits through the extractate line 2014. Some blood passes directly from the supply line 2016 to the return line 2014 via a bypass line 2140. The supply and return lines are connected to headers within the module 2000 which are formed by openings in the plates 2002, 2004, 2006, and 2008. Fasteners 2008 and 2016 such as bolts are used to compress the stack of plates together to form tight seals, similar to those discussed above with regard to FIGS. 15 through 18B.

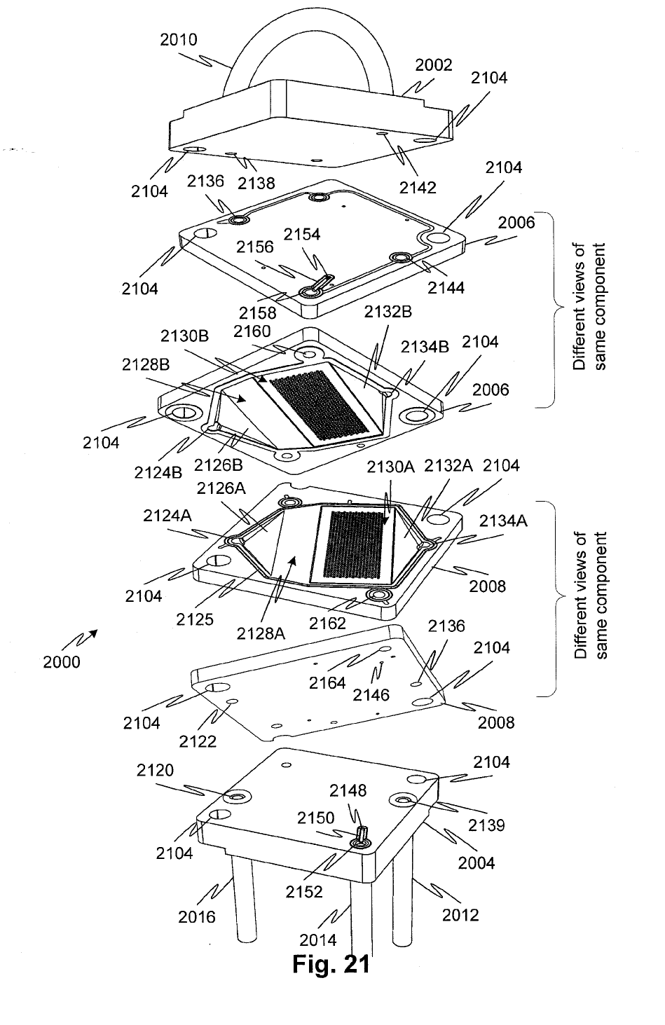

Referring now to FIG. 21, the top end plate 2002 has openings 2138 and 2142 which communicate with the bypass line 2010. An opening 2136 in the upper intermediate plate 2006, which opens at opening 2124B in a reverse surface of the same plate (shown from above and below in the same drawing as indicated) mates with opening 2124A in the lower intermediate plate 2008. The opening 2124A opens 2122 on the opposite face of the latter plate 2008 and communicates with opening 2120 and supply line 2016.

An opening 2144 in the upper intermediate plate 2006, which opens at opening 2134B in a reverse surface of the same plate (shown from above and below in the same drawing as indicated) mates with opening 2134A in the lower intermediate plate 2008. The opening 2134A opens at 2136 on the opposite face of the latter plate 2008 and communicates with opening 2139 and return line 2012.

The above openings above and elsewhere may be sealed by seal ribbons such as indicated at 2125 and which run around all the recesses and openings that are sealed between the plates and can have the characteristic structures described with reference to FIGS. 18A and 18B. The ridges may or may not be present.

Sample fluid flowing into the supply line 2016 enters a spreading plenum defined between recesses 2126A and 2126B which distributes the sample fluid to a settling channel defined between flat recesses 2128A and 2128B. The channel continues to a portion defined between the two nanopore filters 2130A and 2130B. The sample fluid then flows into an exiting plenum defined between recesses 2132A and 2132B and then exits through opening 2134A where it meets the bypass flow from the bypass line 2010.

The extractate passes out of the sample fluid through the nanopore filters 2130A and 2130B into narrow plenums beneath each one (not visible in the present figure) where the extract exits the plenums from the openings 2146 in the lower intermediate 2008 plate and 2154 in the upper intermediate plate 2006. The extractate is gathered through a takeoff channel 2156 and flows through an opening 2158 which opens below the upper intermediate plate 2006 at 2160. The extractate from opening 2160 and passing through opening 2162, which opens at 2164 in an opposite face of the lower intermediate plate 2008, joins extractate that leaves the lower plenum through opening 2146 which is conveyed along takeoff channel 2156. Both extractate streams exit through opening 2152 which opens to the extractate line 2014.

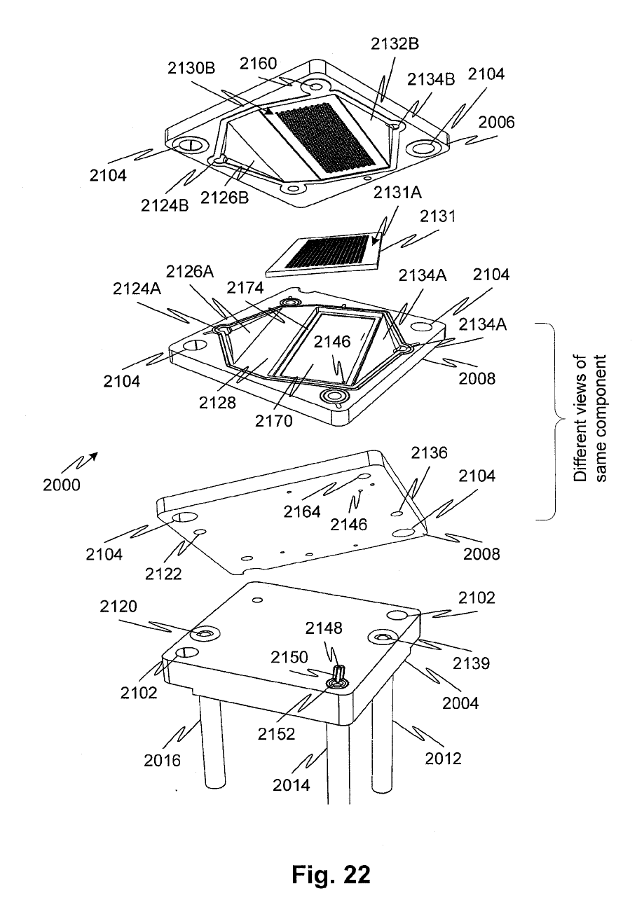

Openings 2104 are for fasteners. Referring to FIG. 22, the nanopore filter 2131 sealed to lower intermediate plate 2008 is shown removed to reveal the underlying extractate plenum 2170 and the opening 2146 through which extractate leaves it. The nanopore filter may be sealed to the lower intermediate plate 2008 by an adhesive, by a compression seal, or by any suitable means. In the illustrated embodiment, a shelf 2174 provides a surface for bonding the filter 2131.

To provide for multiple channels, the intermediate plates 2006 and 2008 are replicated to create a higher stack of plates. The flows of sample fluid and extractate are distributed and gathered by manifolds that extend through the multiple plate layers.

In an assembly method, the nanopore filters may be adhered to the intermediate plates. Sealant material may be distributed to form the seals in the plates. Then the intermediate and end plates are stacked and fastened together such that a compression force is applied to the seals.

The module of FIGS. 20A and 20B may be employed in the flow circuit described with reference to FIG. 1B, for example. In embodiments, only one nanopore filter is used in each channel and it is located on a single side of the channel.

In any of the embodiments, surfaces that may be in contact with blood and/or blood components may be coated with materials that are more biocompatible and smoother. Surfaces that may be in contact with any fluid (e.g., blood or sheath fluid) may be coated. Coatings may be chosen so as to reduce surface roughness relative to the underlying material or junctions between elements. Coatings may be selected to be effective to reduce, blood protein adsorption and to and/or fouling of layer surfaces. Coatings applied to the filter layers may be chosen and applied such that the pores or holes of filters, such as the filters 532, are not blocked or substantially reduced in size. For example, a suitable coating may include polyethylene glycol (PEG) or other organic polymer coatings. The coating may be applied before or after assembly of the various layers.

Although specific materials and arrangements have been disclosed herein, materials for the various layers of the blood-plasma separation module are not limited to those materials. Other materials are also possible according to one or more contemplated embodiments. Furthermore, although specific fabrication methodologies are discussed above, such fabrication techniques are illustrative only. Other fabrication techniques are also possible, especially when working with different materials.

Cleaning of the blood-plasma separation device and its various components is possible using any means sufficient to remove blood or blood components from the flow channels of the blood-plasma separation device and to sterilize the device for its next use. One or more cleaning processes described herein or known in the art may be used alone or in tandem to clean the blood-plasma separation module and thereby prepare it for use by a patient. For example, an appropriate detergent may be flushed through the blood-plasma separation device for a period of time sufficient to remove organic substances from the flow channels in the blood-plasma separation device. After the period of time has expired, a rinse may be performed to purge the device of any remaining detergent. In another example, the device may be filled with a cleaner/sterilizer, such as germicide or sulfuric acid, and maintained with the cleaner/sterilizer therein for a set period of time, for example, 12 hours. After the set time, the blood-plasma separation device may be purged by flowing a solvent through the flow channels therein so as to clear the blood-plasma separation device of any cleaner. In still another example, water at an elevated temperature, such as 80° C., may be flushed through the device for a period of time sufficient to kill germs or bacteria that may be present in the device. Ultrasonic cleaning methods may also be employed. Accordingly, materials for the blood-plasma separation device may be chosen to minimize the potential for surface fouling as well as to be compatible with the desired cleaning process or processes.

Note that as used herein, the term “extracorporeal” is not necessarily limited to the removal of blood from the patient body envelope. Microfluidic extraction channels that are implanted in the bodies of patients are not intended to be excluded from the scope of the present disclosure.

Features of the disclosed embodiments may be combined, rearranged, omitted, etc., within the scope of the invention to produce additional embodiments. Furthermore, certain features may sometimes be used to advantage without a corresponding use of other features.

Note that although in the embodiments described throughout, channel widths much greater than the examples given may also be used to generate the diffusion and cytoplasmic body-polarization effects described herein. For example, it is possible to have separation channels that are 1000 microns or more. In embodiments, channel thickness of about 500 microns or less are employed.

It is, thus, apparent that there is provided, in accordance with the present disclosure, multi-layered fluid separation devices, systems, and methods employing multi-layered separation components for processing fluids. Many alternatives, modifications, and variations are enabled by the present disclosure. While specific embodiments have been shown and described in detail to illustrate the application of the principles of the invention, it will be understood that the invention may be embodied otherwise without departing from such principles. Accordingly, Applicants intend to embrace all such alternatives, modifications, equivalents, and variations that are within the spirit and scope of the present invention.

1. A microfluidic separation device, comprising:
a plurality of flow channels, each having parallel facing opposing walls separated by a separation distance of 500 microns or less;
each of the walls having first and second opposite ends separated by a length between 0.5 cm and 10 cm;
an inlet opening at each of the first ends and a plurality of outlet openings along the walls spanning a streamwise span of the walls and running toward the second ends;
each of the outlet openings having a minimum dimension that is less than 6 microns;
the streamwise span of each of the walls being 0.5 cm or more;
each of the inlets opening being configured to receive fluid from an inlet manifold;
the inlet manifold being configured to supply fluid to each of the plurality of flow channels;
each of the outlet openings being configured to supply fluid to a plenum, each plenum having an extractate opening and an extractate channel configured to supply fluid to an outlet manifold;
the inlet and outlet manifolds each providing flow to and from multiple flow channels;
each plenum being defined by a recess in an intermediate plate, the recess being covered by a filter plate with the outlet openings;
a surface of each filter plate being substantially coplanar with the walls at the first ends;
the extractate channel being formed in a recess of at least some of the intermediate plates such that each extractate opening opens to an adjacent extractate channel;
the inlet and outlet openings being formed by sealed adjacent openings between the intermediate plates;
an extractate manifold being formed by sealed adjacent openings between the intermediate plates, each extractate channel connecting at least one extractate opening to the extractate manifold; and
a bypass line between the inlet and outlet manifolds.

2. The device of claim 1, wherein at least one of the intermediate plates has a tapered recess connecting the inlet opening to a respective flow channel.

3. The device of claim 1, further comprising a recirculating flow circuit connecting the inlet and extractate manifolds.

4. The device of claim 3, wherein the recirculating flow circuit has a fluid processor configured to alter a property of a fluid flowing therein.

5. The device of claim 4, wherein the recirculating flow circuit includes a filter membrane and the recirculating flow circuit is continuous along one side of the membrane such that filtrate can be extracted from fluid in the recirculating flow circuit.

6. The device of claim 1, wherein the flow channel is a rectangular flow channel, and the walls are facing opposing walls whose widths are at least ten times the separation distance between them.

7. A microfluidic separation device, comprising:
a flow channel having parallel facing opposing walls separated by a separation distance;
the separation distance being less than 200 microns;
each wall having first and second opposite ends separated by a length sufficient to cause cells in human blood, flowing through the flow channel at a velocity of at least 1 cm/sec, to concentrate in a region intermediate between the walls and leave substantially cell free plasma layers adjacent to the walls;
each wall having an array of outlet openings at the second end;
the outlet openings having a minimum dimension that is less than 6 microns;
the array spanning a lengthwise portion of each of the walls of at least 0.5 cm.

8. The device of claim 7, wherein the flow channel has at least one inlet that is connectable to a patient access to receive blood therefrom.

9. The device of claim 8, wherein the outlet openings are connected to a return channel fluidly coupled to the at least one inlet.

10. The device of claim 7, wherein the walls are cylindrical and coaxial.

11. The device of claim 7, wherein the flow channel is a rectangular flow channel and the walls are facing opposing walls whose widths are at least ten times a separation distance between them.

12-28. (canceled)

29. A microfluidic separation device, comprising:
multiple members each pair forming a flow channel having parallel facing opposing walls of the members, the wall being separated by a separation distance to define the flow channel;
the separation distance being 500 microns or less;
each wall having first and second opposite ends separated by a length between 0.5 cm and 10 cm;
each of the members having an inlet and outlet openings to the flow channel and channels formed by recesses in the wall, the recesses being closed by adjacent walls of adjacent ones of the members, the adjacent ones having facing oppositely-directed recesses or flat surfaces that complement the each of the members recesses to form closed channels.

30. The device of clam 29, wherein a first of the closed channels for each flow channel is configured to communicate with a plenum that communicates with the outlet openings.

31. The device of claim 29, wherein the closed channels communicate with outlet manifold openings in the members that collectively form a collection manifold that fluidly communicates between all of the multiple closed channel openings.

32. The device of claim 29, wherein the members are configured such that N channels can be provided with respective inlet and outlet openings with no more than 2*N−1 of the members and two further members in a stack configuration.

33. The device of claim 29, wherein the inlets communicate with an inlet manifold that communicates via a bypass channel with the collection manifold.
